(19) United States
(12) Patent Application Publication
(10) Pub. No.: US 2005/0071877 A1
(43) Pub. Date: Mar. 31, 2005

(54) Satellite downstream porting interface API

(76) Inventor: Efren N. Navarro, Lake Forest, CA (US)

Correspondence Address: GARLICK HARRISON & MARKISON LLP, P.O. BOX 160727, AUSTIN, TX, 78716-0727, US

(21) Appl. No.: 10/876,791

(22) Filed: Jun. 25, 2004

Related U.S. Application Data
(60) Provisional application No. 60/505,789, filed on Sep. 25, 2003.

(51) Int. Cl. H04N 7/20; H04N 7/173

(52) U.S. Cl. 725/68; 725/131; 725/70

(57) ABSTRACT

Satellite downstream porting interface API. A novel solution is presented to support various integrated and non-integrated functional blocks within the front-end of a satellite receiver STB (Set Top Box) system. Embedded software, running on an integrated microprocessor within a single chip STB device, is implemented to govern various devices within the satellite STB system. The embedded software may control operational parameters of an external LNB (Low Noise Block) on a satellite dish employed by a user; this may include controlling the polarization of the LNB as well as the associated voltages levels employed by the LNB. The embedded software may also direct the tuning frequency and cut-off frequency of 1 or more SDSs (integrated downstream satellite receivers) receiving output from the satellite dish. The embedded software may also direct many of the various operational parameters of 1 or more SDSs including modulation, code rate, and/or symbol rate of received signals.

### CROSS REFERENCE TO RELATED PATENTS/PATENT APPLICATIONS

The present U.S. Utility Patent Application claims priority pursuant to 35 U.S.C. § 119(e) to the following U.S. Provisional Patent Application which is hereby incorporated herein by reference in its entirety and made part of the present U.S. Utility Patent Application for all purposes:

1. U.S. Provisional Application Ser. No. 60/505,789, entitled “Satellite downstream porting interface API,” (Attorney Docket No. BP3304), filed Sep. 25, 2003 (09/25/2003), pending.

### BACKGROUND OF THE INVENTION

1. Technical Field of the Invention

The invention relates generally to communication systems; and, more particularly, it relates to directing communication between various modules within a communication receiver device and any associated peripherals.

2. Description of Related Art

Communication systems have been under continual development for many years. One particular type of communication system is that of a satellite television communication system. These communication systems typically are uni-directional broadcast types of communication systems, in that, media is provided from a centralized region via any of a number of channels to multiple users. Each of these multiple users typically has his own satellite dish and STB (Set Top Box) that is operable to receive, demodulate, decode, and process signals received via the satellite dish into a format that is appropriate for a compatible display.

While this overall STB system (at the user-end/receiver-end) may be viewed as being relatively simplistic from a user's perspective (by including only a satellite dish and a STB), an overall STB system is in fact a complex system. The received signals are typically provided to a tuner, whose output is provided to a satellite downstream receiver, whose output is subsequently provided to a device that is capable of performing subsequent processing (including decoding) to comport the received signal into a format such that the media included therein may be output to a compatible display. Each of these blocks is typically implemented using separate functional blocks and/or integrated circuits. For example, the tuner is typically implemented as an individual integrated circuit. The satellite downstream receiver is also typically implemented as an individual integrated circuit. The processing (including decoding) functional block is typically implemented as a number of integrated circuit and/or functional blocks as well.

Each of these components of the overall STB system needs to be controlled to perform proper demodulation and decoding of received signals into a format that comports with a compatible display. Moreover, when a user of the overall STB system wishes to perform a channel change (e.g., select different media for viewing and/or listening), then 1 or more of the operational parameters for each of the components of the overall STB system may need to be modified. That is to say, each of the components of the overall STB system includes 1 or more operational parameters that governs its operation. When a channel change is to occur, 1 or more of the operational parameters of 1 or more of these components of the overall STB system may need to be modified. As can be quickly understood, the control and feedback within such a system can be significant. Particularly given the fact that overall STB system typically does include multiple components (that may each include multiple functional blocks and/or integrated circuits), the control challenges to ensure that each of these components (and any of their respective functional blocks and/or integrated circuits) becomes exacerbated. In addition, many of these components have unique (oftentimes proprietary) means and ways by which their operational parameters may be changed. The challenges to a designer of such a system can be extremely difficult to ensure appropriate compatibility between each of the various components of the overall STB system. Generally, the prior art manner by which control of the various components within the overall STB system is performed can be very inefficient.

### BRIEF SUMMARY OF THE INVENTION

Various aspects of the invention can be found in a satellite receiver STB (Set Top Box) system. Such a satellite receiver STB system may include various components including a satellite dish that is communicatively coupled to one or more corresponding satellite receiver STBs. For example, in one embodiment, the satellite receiver STB system includes a single chip satellite receiver STB that includes an integrated microprocessor that is operable to run satellite downstream porting interface API (Application Programming Interface) software and an SDS (integrated downstream satellite receiver) communicatively couple to the integrated microprocessor. That is to say, a single integrated circuit is implemented to support the various functionality of the satellite receiver STB within the overall satellite receiver STB system. In addition, within this embodiment, the satellite receiver STB system includes at least one off-chip satellite tuner, communicatively coupled to the single chip satellite receiver STB, that is operable to extract I, Q (In-phase, Quadrature) components of a received signal and is operable to pass the I, Q components to the SDS of the single chip satellite receiver STB.

In this embodiment, the integrated microprocessor of the single chip satellite receiver STB is operable to provide first control signals to the off-chip satellite tuner via an I²C (inter-integrated circuits) bus as directed by the satellite downstream porting interface API software. In addition, within the single chip satellite receiver STB, the integrated microprocessor of the single chip satellite receiver STB is operable to provide second control signals to the SDS as directed by the satellite downstream porting interface API software. The satellite downstream porting interface API software that runs on the integrated microprocessor of the single chip satellite receiver STB governs at least one operational parameter of the off-chip satellite tuner when receiving a signal, and the satellite downstream porting interface API software that runs on the integrated microprocessor of the single chip satellite receiver STB governs at least one operational parameter of the SDS when demodulating and subsequently decoding the I, Q components of the received signal.

In certain embodiments, the single chip satellite receiver STB includes an integrated DiSEqC (Digital Satellite Equipment Control) functional block that is operable to communicate with an LNB (Low Noise Block) of a satellite dish. Within the single chip satellite receiver STB, third control signals are communicatively coupled from the integrated microprocessor to the integrated DiSEqC functional block, and the integrated DiSEqC functional block is operable to provide DiSEqC control signals to adjust at least one of a voltage and a polarization of the LNB of the satellite dish. Alternatively and/or in addition, the satellite downstream porting interface API software that runs on the integrated microprocessor of the single chip satellite receiver STB may be implemented to govern at least one operational parameter of the control words employed by the DiSEqC functional block to control the LNB of the satellite dish. In such an embodiment, the satellite downstream porting interface API software that runs on the integrated microprocessor of the single chip satellite receiver STB may also be implemented to govern at least one operational parameter of the control words employed by the DiSEqC functional block to control the LNB of the satellite dish in response to a channel change request that is provided to the single chip satellite receiver STB.

Moreover, in some embodiments, the second control signals that are communicatively coupled from the integrated microprocessor to the SDS include information corresponding to at least one of a modulation, a code rate, and a symbol rate by which the received signal is to be demodulated and subsequently decoded. The at least one operational parameter employed by the off-chip satellite tuner when receiving a signal may include at least one of a tuning frequency and a cut off frequency.

Various of the operations and operations performed by the various functional blocks within the overall satellite receiver STB system may be performed in response to various system stimulus. For example, a request for a channel change made by a user of the satellite receiver STB system may initiate the satellite downstream porting interface API software that runs on the integrated microprocessor of the single chip satellite receiver STB to direct various functional blocks within the satellite receiver STB system to perform certain functions.

As some examples, the satellite downstream porting interface API software that runs on the integrated microprocessor of the single chip satellite receiver STB governs at least one operational parameter of the off-chip satellite tuner when receiving a signal in response to a channel change request that is provided to the single chip satellite receiver STB. Analogously, the satellite downstream porting interface API software that runs on the integrated microprocessor of the single chip satellite receiver STB governs at least one operational parameter of the SDS when demodulating and subsequently decoding the I, Q components of the received signal in response to a channel change request that is provided to the single chip satellite receiver STB. The satellite downstream porting interface API software that runs on the integrated microprocessor of the single chip satellite receiver STB is also operable to modify any of the operational parameters employed by the SDS, the DiSEqC governed control of the LNB, and/or the off-chip satellite tuner. That is to say, the satellite downstream porting interface API software is operable to govern, direct, and/or modify many of the various operational parameters of many of the various functional blocks within the satellite receiver STB system. In some embodiments, this control and direction performed by the satellite downstream porting interface API software is directed primarily to the front end of the satellite receiver STB system.

The satellite receiver STB system described herein may be implemented within a wide variety of systems including a satellite communication system or an HDTV (High Definition Television) communication system.

The invention envisions any type of device that supports the functionality and/or processing described herein. Moreover, various types of methods may be performed to support the functionality described herein without departing from the scope and spirit of the invention as well.

### BRIEF DESCRIPTION OF THE SEVERAL VIEWS OF THE DRAWINGS

FIG. 1 is a system diagram illustrating an embodiment of a satellite communication system that is built according to various aspects the invention.

FIG. 2 is a system diagram illustrating an embodiment of a HDTV (High Definition Television) communication system that is built according to various aspects the invention.

FIG. 3 is a system diagram illustrating an embodiment of a satellite STB (Set Top Box) system that is built according to various aspects the invention.

FIG. 4 is a system diagram illustrating another embodiment of a satellite STB (Set Top Box) system that is built according to various aspects the invention.

FIG. 5 is a diagram illustrating an embodiment of a functional block diagram of an SDS (integrated downstream satellite receiver) (shown as having an integrated DiSEqC (Digital Satellite Equipment Control) functional block) that is arranged according to various aspects the invention.

FIG. 6 is a diagram illustrating an embodiment of STB (Set Top Box) software stack hierarchy that is employed according to various aspects the invention.

FIG. 7 is a diagram illustrating an embodiment of functionality supported by satellite downstream porting interface API (Application Programming Interface) software that is implemented according to various aspects the invention.

FIG. 8 is a flowchart illustrating an embodiment of a method for perform channel change using satellite downstream porting interface API according to various aspects the invention.

### DETAILED DESCRIPTION OF THE INVENTION

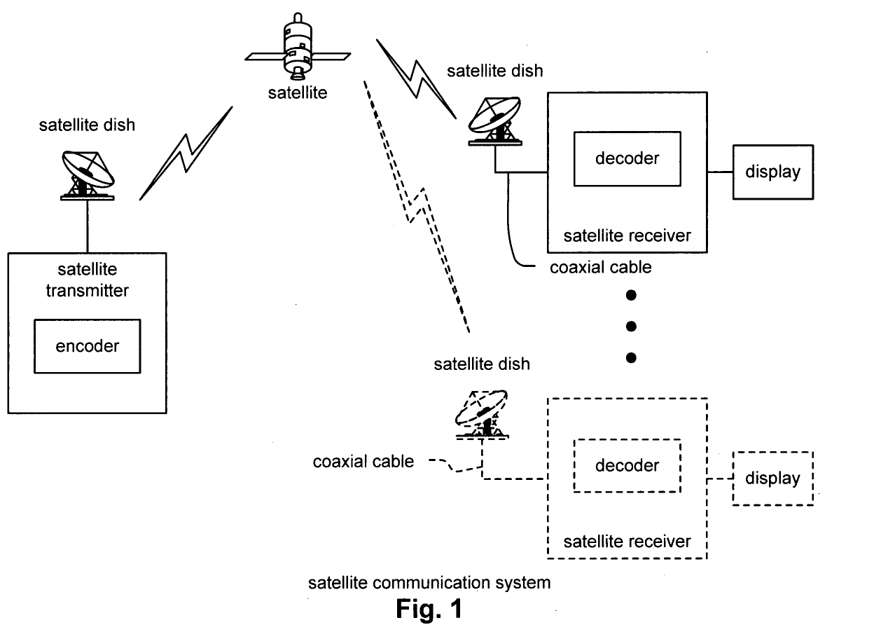

FIG. 1 is a system diagram illustrating an embodiment of a satellite communication system that is built according to various aspects the invention. A satellite transmitter is communicatively coupled to a satellite dish that is operable to communicate with a satellite. The satellite transmitter may also be communicatively coupled to a wired network. This wired network may include any number of networks including the Internet, proprietary networks, other wired networks and/or WANs (Wide Area Networks). The satellite transmitter employs the satellite dish to communicate to the satellite via a wireless communication channel. The satellite is able to communicate with one or more satellite receivers (each having a satellite dish). Each of the satellite receivers may also be communicatively coupled to a display.

Here, the communication to and from the satellite may cooperatively be viewed as being a wireless communication channel, or each of the communication links to and from the satellite may be viewed as being two distinct wireless communication channels.

For example, the wireless communication “channel” may be viewed as not including multiple wireless hops in one embodiment. In other multi-hop embodiments, the satellite receives a signal received from the satellite transmitter (via its satellite dish), amplifies it, and relays it to satellite receiver (via its satellite dish); the satellite receiver may also be implemented using terrestrial receivers such as satellite receivers, satellite based telephones, and/or satellite based Internet receivers, among other receiver types. In the case where the satellite receives a signal received from the satellite transmitter (via its satellite dish), amplifies it, and relays it, the satellite may be viewed as being a “transponder;” this is a multi-hop embodiment. In addition, other satellites may exist that perform both receiver and transmitter operations in cooperation with the satellite. In this case, each leg of an up-down transmission via the wireless communication channel would be considered separately.

In whichever embodiment, the satellite communicates with the satellite receiver. The satellite receiver may be viewed as being a mobile unit in certain embodiments (employing a local antenna); alternatively, the satellite receiver may be viewed as being a satellite earth station that may be communicatively coupled to a wired network in a similar manner in which the satellite transmitter may also be communicatively coupled to a wired network.

The satellite transmitter is operable to encode information (using an encoder) that is to be transmitted to the satellite receiver; the satellite receiver is operable to decode the transmitted signal (using a decoder). Within the satellite receiver, a satellite downstream porting interface API (Application Programming Interface) is operable to direct the manner in which various functional blocks within the satellite receiver operate. This may include controlling the manner in which a signal received at the satellite dish is treated. This may also include controlling the manner in which various front end circuitries within the satellite receiver operate on a received signal. It may also include controlling the manner in which a received signal is demodulated and decoded. For example, the satellite receiver may receive different types of signals of varying types of signals.

In most instances, the code rate, symbol rate, and modulation type of a signal processed herein are static parameters (i.e., they do not change as a function of time or they are at least constant for predetermined period of times). However, in some instances, the code rate, symbol rate, modulation type (or even some other signal parameter) may be modified to be different values at different times. Generally speaking, these parameters change in value only when directed by and in response to a change in those parameters that is made and requested in the head-end (i.e., the modulator end). Also generally speaking, the acquisition parameters by which the signal is to be processed (e.g., including modulation type, symbol rate, code rate, IF (Intermediate Frequency), output MPEG-2 transport interface, and other signal parameters) are configured per channel acquisition as initiated and directed by the satellite downstream porting interface API.

The satellite downstream porting interface API allows a user to configure the various functional blocks to operate appropriately such that the satellite receiver properly receives, demodulates, and decodes the received signals. The satellite downstream porting interface API provides a great deal of flexibility in controlling the manner in which the satellite downstream porting interface operates.

The satellite downstream porting interface API ensures that the operational parameters that govern the satellite downstream porting interface may be configurable to ensure proper handling of such signals. This diagram shows just one of the many embodiments where one or more of the various aspects of the invention may be found.

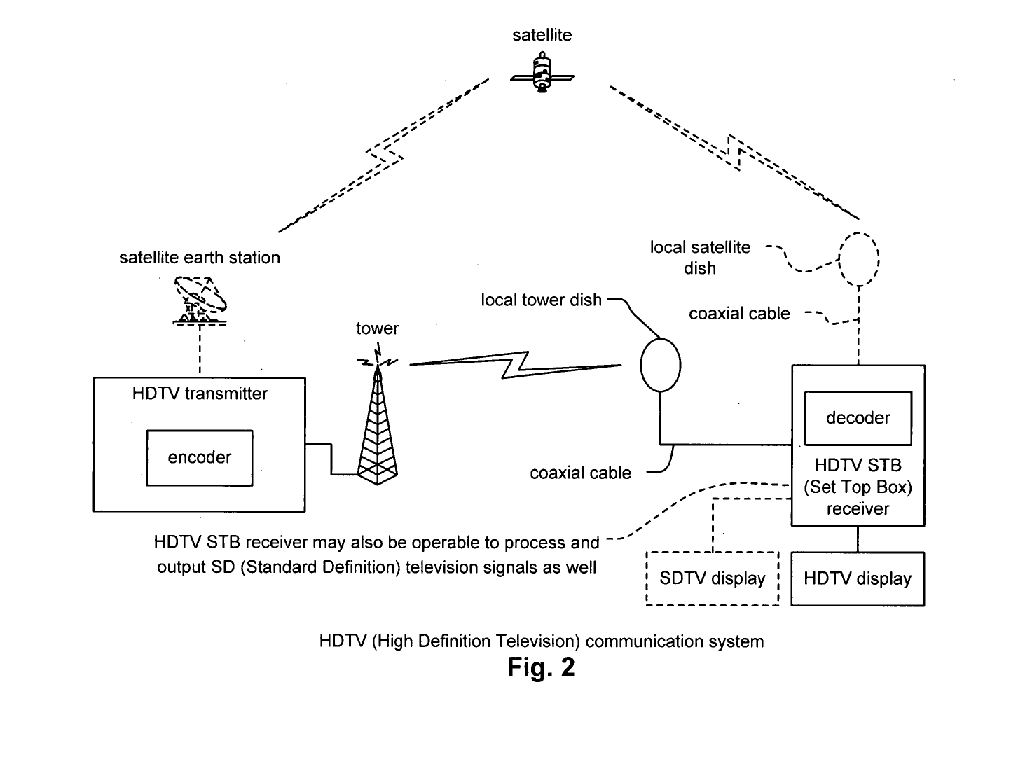

FIG. 2 is a system diagram illustrating an embodiment of an HDTV (High Definition Television) communication system that is built according to the invention. An HDTV transmitter is communicatively coupled to a tower. The HDTV transmitter, using its tower, transmits a signal to a local tower dish via a wireless communication channel. The local tower dish may communicatively couple to an HDTV STB (Set Top Box) receiver via a coaxial cable. The HDTV STB receiver includes the functionality to receive the wireless transmitted signal that has been received by the local tower dish. This functionality may include any transformation and/or down-converting that may be needed to accommodate for any up-converting that may have been performed before and during transmission of the signal from the HDTV transmitter and its corresponding tower to transform the signal into a format that is compatible with the communication channel across which it is transmitted. For example, certain communication systems step a signal that is to be transmitted from a baseband signal to an IF (Intermediate Frequency) signal, and then to a carrier frequency signal before launching the signal into a communication channel. Alternatively, some communication systems perform a conversion directly from baseband to carrier frequency before launching the signal into a communication channel. In whichever case is employed within the particular embodiment, the HDTV STB receiver is operable to perform any down-converting that may be necessary to transform the received signal to a baseband signal that is appropriate for demodulating and decoding to extract the information there from.

The HDTV STB receiver is also communicatively coupled to an HDTV display that is able to display the demodulated and decoded wireless transmitted signals received by the HDTV STB receiver and its local tower dish. The HDTV STB receiver may also be operable to process and output SD (Standard Definition) television signals as well. For example, when the HDTV display is also operable to display standard definition television signals, and when certain video/audio is only available in standard definition format, then the HDTV STB receiver is operable to process those standard definition television signals for use by the HDTV display (though at a lower quality and capability than the HDTV display is capable to output).

The HDTV transmitter (via its tower) transmits a signal directly to the local tower dish via the wireless communication channel in this embodiment. In alternative embodiments, the HDTV transmitter may first receive a signal from a satellite, using a satellite earth station that is communicatively coupled to the HDTV transmitter, and then transmit this received signal to the local tower dish via the wireless communication channel. In this situation, the HDTV transmitter operates as a relaying element to transfer a signal originally provided by the satellite that is ultimately destined for the HDTV STB receiver. For example, another satellite earth station may first transmit a signal to the satellite from another location, and the satellite may relay this signal to the satellite earth station that is communicatively coupled to the HDTV transmitter. In such a case the HDTV transmitter include transceiver functionality such that it may first perform receiver functionality and then perform transmitter functionality to transmit this received signal to the local tower dish.

In even other embodiments, the HDTV transmitter employs its satellite earth station to communicate to the satellite via a wireless communication channel. The satellite is able to communicate with a local satellite dish; the local satellite dish communicatively couples to the HDTV STB receiver via a coaxial cable. This path of transmission shows yet another communication path where the HDTV STB receiver may communicate with the HDTV transmitter.

In whichever embodiment and by whichever signal path the HDTV transmitter employs to communicate with the HDTV STB receiver, the HDTV STB receiver is operable to receive communication transmissions from the HDTV transmitter and to demodulate and decode them appropriately.

Similar to the embodiment described above, the HDTV STB receiver includes a satellite downstream porting interface API (Application Programming Interface) that is operable to direct the manner in which various functional blocks within the HDTV STB satellite receiver operate; the satellite downstream porting interface API may also be implemented to control the operation of the local tower dish and/or the local satellite dish as within the scope and spirit of the invention. This diagram shows yet another embodiment where one or more of the various aspects of the invention may be found.

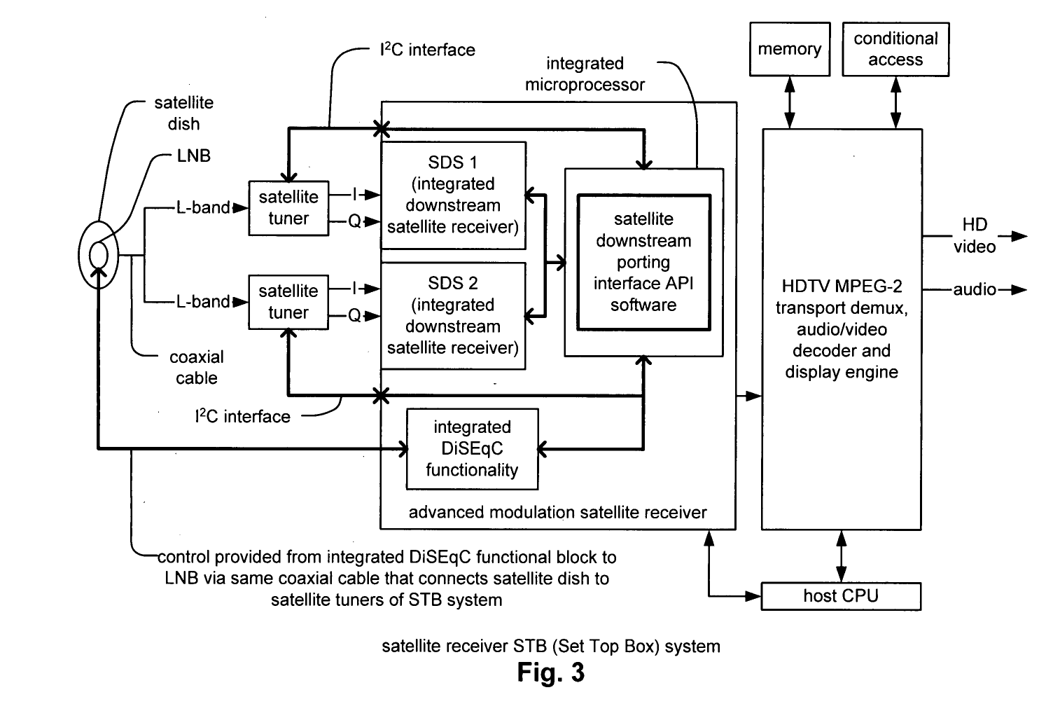

FIG. 3 is a system diagram illustrating an embodiment of a satellite STB (Set Top Box) system that is built according to various aspects the invention. The satellite receiver STB system includes a satellite dish having an LNB (Low Noise Block) that communicatively couples to 2 separate satellite tuners. The outputs of these satellite tuners communicatively couple to an advanced modulation satellite receiver. The satellite receiver STB system may include an advanced modulation satellite receiver that is implemented in an all digital architecture. Moreover, the advanced modulation satellite receiver may be implemented within a single integrated circuit in some embodiments. For example, in such situations, each of the functional blocks shown within the advanced modulation satellite receiver of this diagram are included within a single integrated circuit.

Looking at this particular embodiment, the satellite receiver STB system includes dual satellite tuners that receive a signal via the L-band. The satellite tuners extract I, Q (In-phase, Quadrature) components from a signal received from the L-band and provides them to the advanced modulation satellite receiver. The advanced modulation satellite receiver includes two SDSs (integrated downstream satellite receivers), shown as an SDS 1 and an SDS 2. Each of the SDS 1 and the SDS 2 perform appropriate demodulation and subsequent decoding of the I, Q signal components that are provided thereto from the corresponding satellite tuners. From certain perspectives in some embodiments, this decoding may be viewed as performing channel decoding. The advanced modulation satellite receiver also includes an integrated microprocessor that includes embedded software that supports the satellite downstream porting interface API (Application Programming Interface) that is operable to direct the manner in which various functional blocks within the satellite receiver STB system operate. For example, the embedded software is also operable to direct the manner in which various functional blocks within the advanced modulation satellite receiver and without the advanced modulation satellite receiver operate. This embedded software is shown as being satellite downstream porting interface API software in this diagram.

The embedded software, operating within the integrated microprocessor, is operable to control the operation of the LNB of the satellite dish via an integrated DiSEqC (Digital Satellite Equipment Control) functional block according to the DiSEqC standard. This may also involve controlling any of a number of operational parameters of control words employed by the DiSEqC functional block (that is implemented within the single chip satellite receiver STB) to control the LNB of a satellite dish. Some of these operational parameters of control words (in accordance with DiSEqC) include tone amplitude, tone frequency, duty cycle, message length, and the time between the various DiSEqC messages employed by the DiSEqC functional block to control various operational parameters of the LNB of the satellite dish including polarization control and voltage control of the LNB of the satellite dish.

In addition, the embedded software is operable to control the tuning frequency (as well as the cut off frequency) of each of the satellite tuners as well as the operational parameters of each of the SDS 1 and the SDS 2. This diagram shows how the embedded software is operable to direct the operation of a variety of functional blocks within the satellite receiver STB system, including the various functional blocks and circuitries of the front end of the STB. Moreover, the embedded software is operable to perform status checks of these various functional blocks and circuitries to assist in testing and monitoring of these functional blocks and circuitries within the satellite receiver STB system.

The advanced modulation satellite receiver may be implemented to communicatively couple to an HDTV MPEG-2 (Motion Picture Expert Group, level 2) transport de-mux, audio/video decoder and display engine. The advanced modulation satellite receiver and the HDTV MPEG-2 transport de-mux, audio/video decoder and display engine communicatively couple to a host CPU (Central Processing Unit). The HDTV MPEG-2 transport de-mux, audio/video decoder and display engine also communicatively couples to a memory module and a conditional access functional block. The HDTV MPEG-2 transport de-mux, audio/video decoder and display engine provides HD (High Definition) video and audio output that may be provided to an HDTV display.

It is also noted that various aspects of the invention as described with respect to this diagram could also be employed when operating within the SD (Standard Television) video and audio technology spaces as well. For example, the advanced modulation satellite receiver may alternatively be implemented to communicatively couple to an SD MPEG-2 transport de-mux, audio/video decoder and display engine without departing from the scope and spirit of the invention.

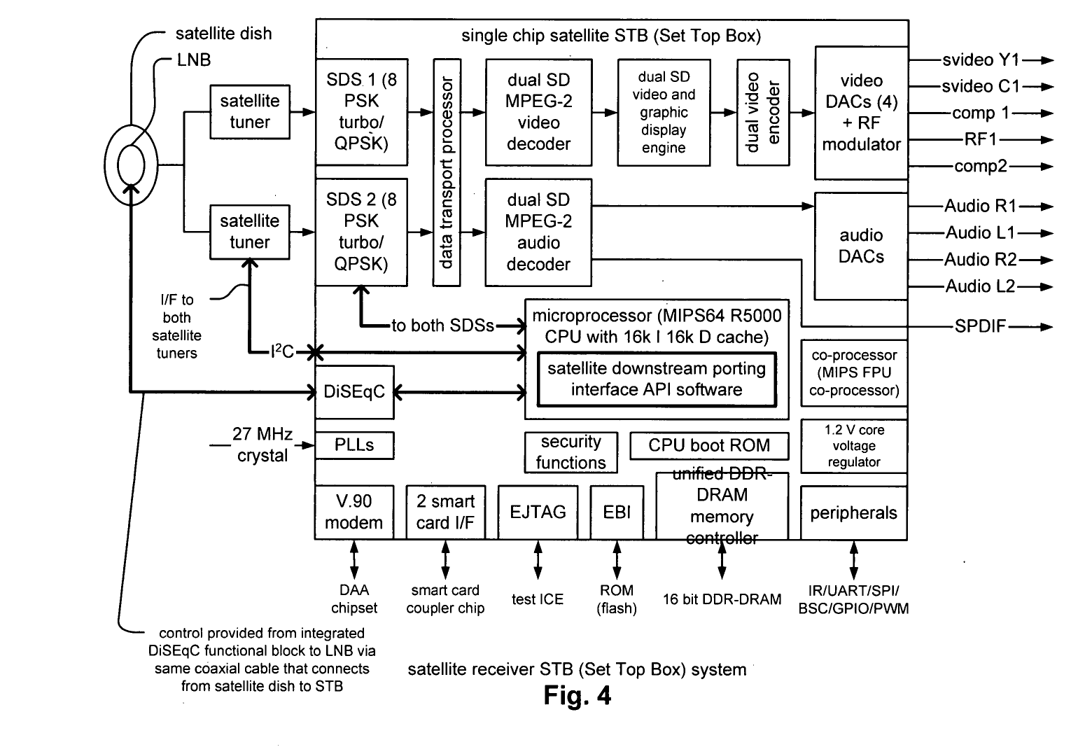

FIG. 4 is a system diagram illustrating another embodiment of a satellite STB (Set Top Box) system that is built according to various aspects the invention.

As within the other embodiments described above, the satellite STB system of this diagram includes a satellite dish having an LNB (Low Noise Block) that communicatively couples to 2 separate satellite tuners. The outputs of these satellite tuners communicatively couple to a single chip satellite STB (Set Top Box). The satellite receiver STB system may include the single chip satellite STB implemented in an all digital architecture within a single integrated circuit in some embodiments.

This diagram shows a device that is a single-chip satellite STB system integrating 8 PSK-Turbo (8 Phase Shift Key-Turbo Code) digital satellite receivers (shown as SDS 1 and SDS 2), MPEG-2 data transport processor, SD-video (Standard Definition-video) MPEG-2 decoder, MPEG-2 audio decoder, 2D graphics technology, modulator, MIPS64 microprocessor, all key interfaces to external memory and I/O, and the necessary peripherals needed in cost sensitive, dual stream STB applications.

The digital satellite receivers (i.e., SDS 1 and SDS 2) accept two modulated data streams at up to 90 Mbps (Mega-bits per second) and deliver demodulated, error-corrected output data streams. Each digital satellite receiver (i.e., each of SDS 1 and SDS 2) consists of dual 8-bit ADCs (Analog to Digital Converters), an all-digital variable rate 8PSK-turbo/QPSK (Quadrature Phase Shift Key) offset QPSK receiver, a DVB (Digital Video Broadcast(ing))/DirecTV/Digicipher II compliant FEC (Forward Error Correction) decoder and all required RAM (Random Access Memory). Each of the digital satellite receivers (i.e., SDS 1 and SDS 2) performs appropriate demodulation and subsequent decoding of the I, Q signal components that are provided thereto from the corresponding satellite tuners. From certain perspectives in some embodiments, this decoding may be viewed as performing channel decoding.

The data transport processor is an MPEG-2/DirecTV transport stream message/PES (Packetized Elementary Stream (MPEG-2)) parser and de-multiplexer. It simultaneously process 64 PIDs (Packet Identifiers) in up to two independent transport streams, with decryption for all 64 PIDs. It supports message/PES parsing for 64 PIDs with storage to 64 external DRAM buffers, and it provides 64 section filters.

The MPEG-2 Video Decoder is designed to decode two SD video streams. It optionally accepts transport (ATSC (Advanced Television Systems Committee)-MPEG/DirecTV), PES or ES streams and self-sufficiently performs all the requisite decoding functions, and renders the decoded video, in 4:2:2 format. A 16-bit DDR-SDRAM (Double Data Rate Synchronous Dynamic Random Access Memory (computer memory)) memory subsystem is configured to work as a Unified Memory Architecture.

The MPEG Audio Decoder is implemented to perform several discrete processing functions. Data is first processed by up to three of the Audio Transport and Interface Processors which handle synchronization and filtering functions. Next, data is sent to up to two of the MPEG Audio Decompression Processors for conversion from compressed audio data to uncompressed PCM (Pulse Code Modulation) audio data. The output PCM audio data can be mixed with PCM audio from the PCM Audio Playback Memory Interface.

The final mixed audio can be output either digitally over an SPDIF (Sony Philips Digital Interface), or in analog mode, through a two-channel audio DAC. Additionally, the output of one of the Audio Transport and Interface Processors can send compressed Dolby data to the SPDIF module to be output on the SPDIF interface simultaneously with decompressed MPEG being output on either of the two DAC outputs.

The graphics engine accepts dual decoded MPEG and performs professional quality compositing of text and graphics with video. The design is hardware intensive with software assist to support a variety of RGB (Red Green Blue), YUV (Luminance-Bandwidth-Chrominance) and CLUT (Color Look Up Table) pixel formats. Text rendition is enhanced with the use of anti-flutter filters, which eliminate the flutter effect that is inherent with the interlaced display of high resolution text and imagery while at the same time not affecting the display of normal or scaled live video, which is meant for interlaced display. NTSC/PAL/SECAM (Sequential Color & Memory) video encoders, a RF modulator, and DACs (Digital to Analog Converters) produce the final composite, S-video, and channel 3/4 outputs.

The chip contains a 252 MHz MIPS64 R5000 class microprocessor subsystem with MMU (Memory Management Unit), 16 kB instruction cache, and 16 kB data cache with bridging to memory and a local bus, where external peripherals can be attached. Peripherals include UARTs (Universal Asynchronous Receiver-Transmitter), Smart Card interfaces, soft modem interface, counter/timers, GPIOs (General Purpose Input/Output), IR Blaster and Receivers. On-Chip PLLs (Phase Locked Loops) provide all internal clocks from a single external 27 MHz (Mega-Hertz) crystal. Finally, an on-chip voltage regulator provides tight tolerance 1.2 V (Volt) for powering the chip core.

The 252 MHz MIPS64 R5000 class microprocessor supports embedded software that supports a satellite downstream porting interface API (Application Programming Interface) that is operable to direct the manner in which various functional blocks within the satellite receiver STB system operate. This embedded software is shown as being satellite downstream porting interface API software in this diagram. As within other embodiments, the embedded software of this embodiment is operable to control the operation of the LNB of the satellite dish via an integrated DiSEqC (Digital Satellite Equipment Control) functional block according to the DiSEqC standard. In addition, the embedded software is operable to control the tuning frequency (as well as the cut off frequency) of the satellite tuners as well as the operational parameters of SDS (integrated downstream satellite receivers) (shown as SDS 1 and SDS 2). The control provided to the satellite tuners from the single chip satellite STB may be performed via I²C (inter-integrated circuits) communication links. This diagram shows how the embedded software is operable to direct the operation of a variety of functional blocks within the satellite receiver STB system, including the various functional blocks and circuitries of the front end of the STB. Moreover, the embedded software is operable to perform status checks of these various functional blocks and circuitries to assist in testing and monitoring of these functional blocks and circuitries within the satellite receiver STB system.

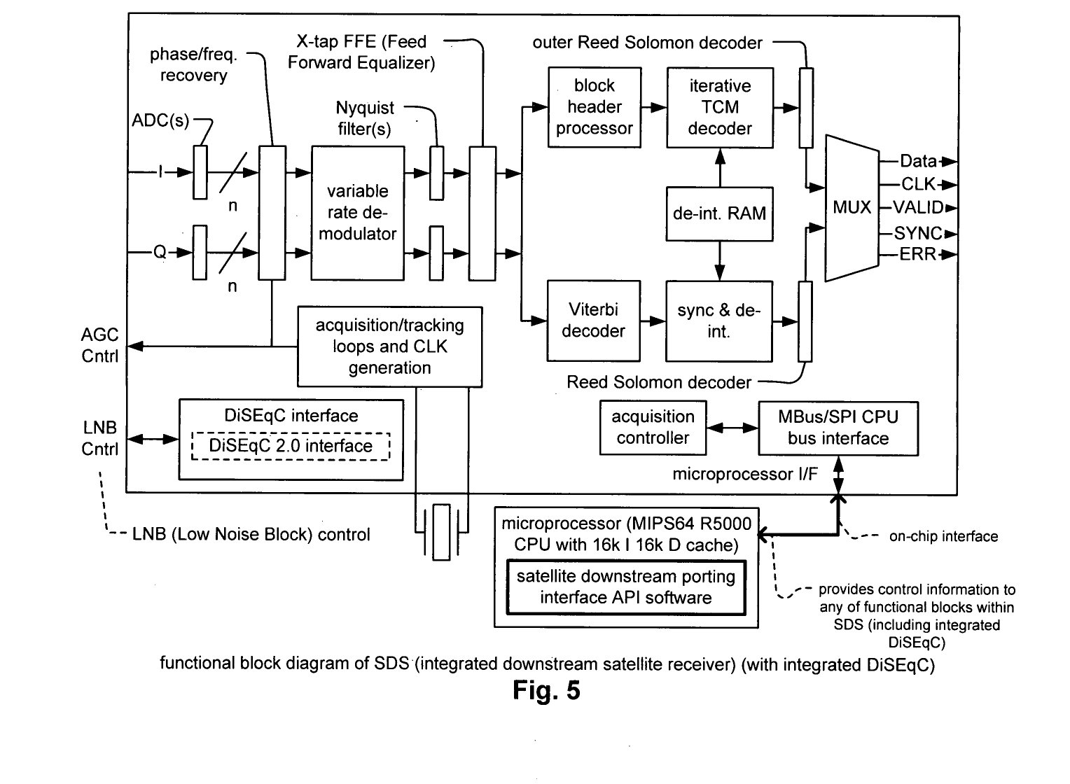

FIG. 5 is a diagram illustrating an embodiment of a functional block diagram of an SDS (integrated downstream satellite receiver) (shown as having an integrated DiSEqC (Digital Satellite Equipment Control) functional block) that is arranged according to various aspects the invention. The satellite receiver provides an integrated modulation receiver and turbo decoder FEC (Forward Error Correction) processor. The design is operable to provide a significant improvement in throughput, an increase of up to 50% in some embodiments, in the same satellite channel at standard QPSK (Quadrature Phase Shift Key) operating points while simultaneously improving BER (Bit Error Rate) performance beyond existing levels. A high performance turbo code FEC (Forward Error Correction) is implemented with all required on-chip RAM (Random Access Memory) to move system operating points near the theoretical limits. A Reed-Solomon outer code is also used to drive BER beyond typical satellite 10E-11 (i.e., 1×10⁻¹¹) limits.

The satellite receiver is a monolithic/single-chip satellite supports BPSK (Binary Phase Shift Key), QPSK (Quadrature Phase Shift Key), 8-PSK (8-Phase Shift Key), and 16 QAM (Quadrature Amplitude Modulation) modulations with iteratively (turbo) decoded error correction coding. The satellite receiver is also operable to support legacy broadcast signals as well.

In this embodiment, the satellite receiver includes dual n-bit ADCs (Analog to Digital Converters), an all-digital variable rate BPSK/QPSK/8-PSK/16 QAM receiver, an advanced modulation turbo FEC decoder and a legacy broadcast signal compliant FEC decoder. All required RAM is integrated and all required clocks are generated on-chip from a single reference crystal. Baseband I, Q analog waveforms are sampled by the integrated n-bit ADCs, resampled by integrated interpolative digital filter banks, and filtered by dual square-root Nyquist filters. Optimized soft decisions are then fed into an FEC decoder, or an advanced modulation turbo decoder. The final error-corrected output is delivered in MPEG-2 transport format (or alternatively DIRECTV transport format). The output clock is generated by an on-chip PLL (Phase Locked Loop) for low-jitter operation with an HD (High Definition) graphics and video subsystem.

The satellite receiver also features a simplified user interface employing an on-chip microcontroller for all system configurations, acquisition, control, and monitoring functions. The host interface to the device is via a simplified, high-level API (Application Programming Interface). This API may be viewed as being the satellite downstream porting interface API (Application Programming Interface) described within the scope and spirit of the invention. Via this satellite downstream porting interface API, the operation of the various functional blocks within the SDS may be controlled. This may include controlling the parameters that govern channel acquisition such as modulation type, code rate, symbol rate, IF (Intermediate Frequency) offset, and output MPEG-2 transport interface characteristics (e.g., clock inversion, width of sync pulse, etc.), as well as other desirable operational parameters employed to receive, demodulate, and decode received signals.

Moreover, the chip may also contain an integrated DiSEqC controller (which may be implemented as a DiSEqC version 2.0 controller in some embodiments) with an integrated voltage regulator for two-way communication with the LNBs (Low Noise Blocks) of the satellite dish. The satellite receiver may itself be viewed as being a master device and one of the LNBs of the satellite dish may be viewed as being a slave device. In this situation, the satellite receiver may be viewed as being a programmable integrated DiSEqC transceiver device, in that, it is able to support two-way communication with the LNB.

As mentioned above, the integrated DiSEqC controller may be implemented using the version 2.0. In this embodiment, the satellite receiver contains a full-featured 2-way DiSEqC 2.0 master transmitter/receiver for LNB slave control. All transmit protocol and receiver demodulation may be handled in hardware. With a few low-cost external discrete components, a complete linear regulator solution can be implemented. Digital output signals are available for 22 kHz (kilo-Hertz) and 13 V/18 V control if an external DiSEqC regulator chip is used in an alternative embodiment.

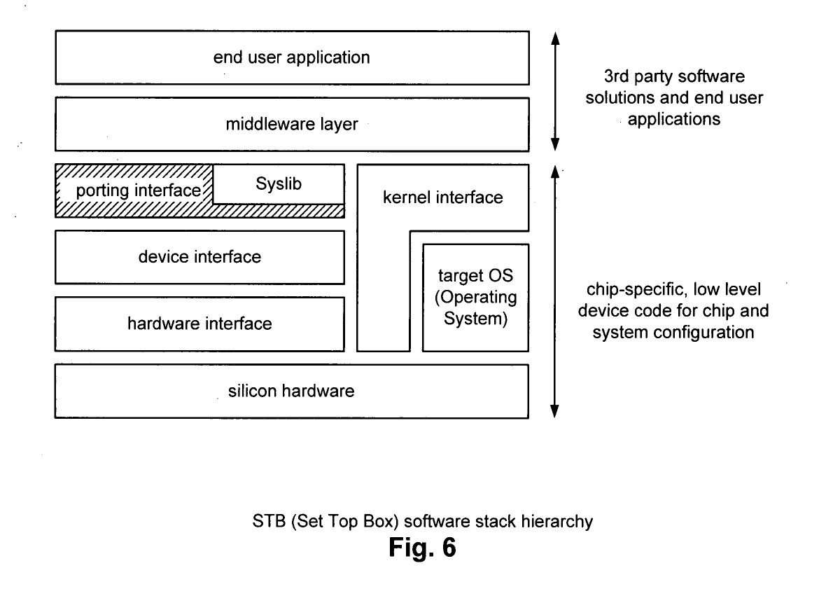

FIG. 6 is a diagram illustrating an embodiment of STB (Set Top Box) software stack hierarchy that is employed according to various aspects the invention. This STB software stack hierarchy provides many benefits to developers. It provides structured software module architecture from chip level to application level. It also provides a hierarchical approach to allow faster development cycles. By using the porting interface, a developer can concentrate on application development to reduce chip-level support issues. The porting interface is maintained across all STB video products to provide the ability to quickly migrate to next-generation devices while preserving application compatibility. This porting interface may be easily expanded to support new features on future products. Developers can develop test applications to exercise hardware based on the porting interface. This STB software stack is a fully-supported product.

The porting interface provides a consistent programming interface for those seeking to aces these internal functions. This porting interface is supported across chip revisions. The porting interface also provides functions to support chip level modules (e.g., transport, graphics, MPEG, and audio/video functions). The porting interface also isolates chip level changes from end-user applications development, and the porting interface can be enhanced to support additional chip features by using the system library (Syslib, described in more detail below) to create additional functionality to perform complex operations.

The system library (shown as Syslib in this diagram) is part of the porting interface and consists of routines and functions to create applications that control system behavior. An example of an application is personal digital video (e.g., fast forward, rewind, start record, and stop record), which makes use of the porting interface and other interfaces. Those seeking to implement such a device can also use functions within Syslib for end-user applications, and they can create extensions to the basic Syslib for increased or added functionality.

The kernel interface is used to standardize calls to the underlying OS (Operating System) or RTOS (Real Time Operating System) from the driver level and/or application layers to provide an easy migration path to other OS's based on market requirements. The kernel interface provides basic operating system-type calls including:
1. thread/task create, delete, and management
2. Semaphore control, create, delete, and management functions
3. Memory management control

The Kernel interfaces may be implemented for many different operating systems including any of the following operating systems: Linux, PowerTV™, Microsoft® TV, WindRiver's VxWorks®, and pSoSystem™, Mentor Graphics VRTX®.

The device interface manages on-chip and board level modules. It acts as an isolation layer between the porting interface and the chip-specific hardware interface, and it has a collection of specific device handlers.

The chip-specific and board-specific hardware interface provides on-chip module initialization, low-level register and bit manipulation routines, and includes system/board level routines. The manufacturer-specific changes based on the chip and board used may reflect manufacturer reference hardware (which is likely to be very different than end-customer hardware). The reference hardware uses high-quality reference code to make it easier for customers to port to their production platform.

The following is a list of supported third-party middleware products that have been ported to use the manufacturer STB software stack interfaces: Microsoft® TV, Liberate™ (On Linux and VxWorks), and PowerTV™.

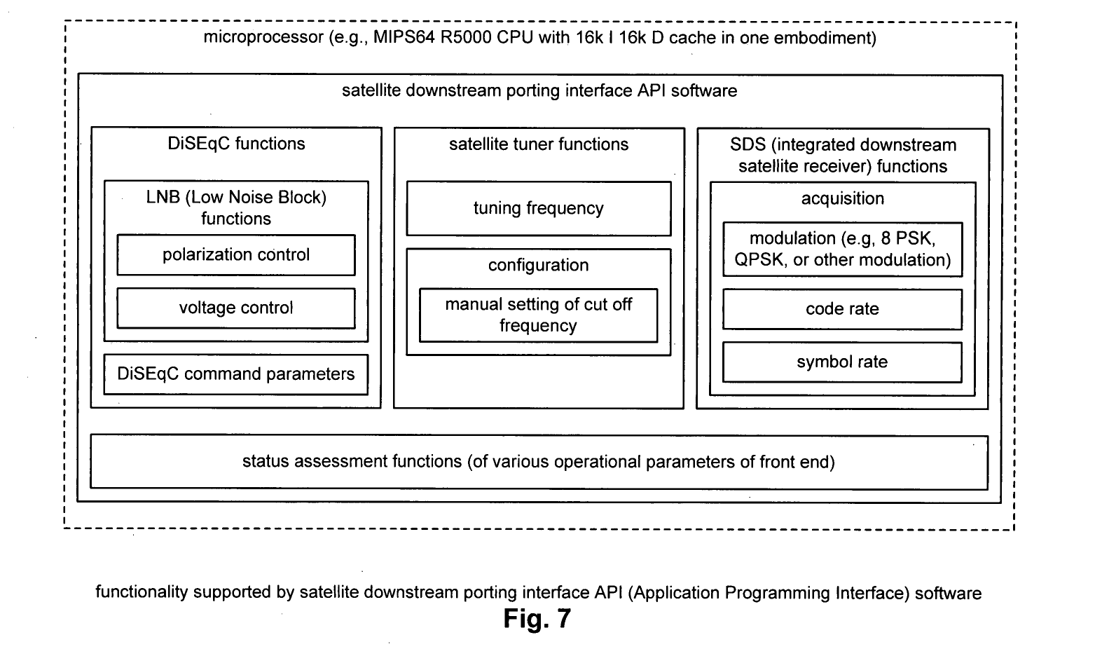

FIG. 7 is a diagram illustrating an embodiment of functionality supported by satellite downstream porting interface API (Application Programming Interface) software that is implemented according to various aspects the invention. The satellite downstream porting interface API software may be implemented to govern a variety of operational parameters within a satellite receiver STB as well as many of the integrated functional blocks (e.g., functional blocks within the chip) and non-integrated functional blocks (e.g., external chips) within the front end of the device.

The satellite downstream porting interface API is operable to direct various DiSEqC functions, various satellite tuner functions, and various SDS (integrated downstream satellite receiver) functions. Some examples of the DiSEqC functions include controlling various LNB (Low Noise Block) functions (as a reminder, the LNB is a component of a satellite dish). The LNB functions may include performing polarization control of the LNB as well as voltage control (which is itself sometimes employed to perform polarization control). Moreover, other examples of DiSEqC functions include controlling various DiSEqC command parameters that may include a voltage level of a PWK (Pulse Width Key) command signal, an amplitude of the PWK command signal, a frequency of the PWK command signal, a duty cycle of the PWK command signal, and a time between messages that are employed according to the DiSEqC standard.

Some examples of the satellite tuner functions include selection of a tuning frequency as well as configuration (such as performing the manual setting of a cut off frequency employed by the satellite tuner.

Some examples of the SDS (integrated downstream satellite receiver) functions include directing the manner in which acquisition is to be performed. This may include controlling the modulation to be employed when symbol mapping received symbols. For example, the SDS may be directed to symbol map 8 PSK (Phase Shift Key) symbols when 8 PSK symbols are expected. Similarly, the SDS may be directed to symbol map QPSK (Quadrature Phase Shift Key) symbols when QPSK symbols are expected. In addition, other modulation types may also be employed without departing from the scope and spirit of the invention. This may also include controlling the code rate and/or symbol rate of the SDS to be employed when demodulating and decoding a received signal.

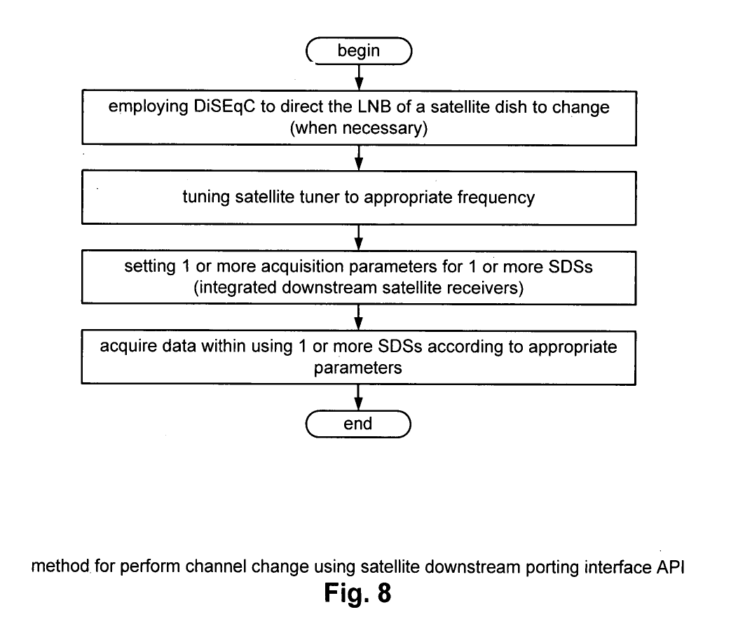

FIG. 8 is a flowchart illustrating an embodiment of a method of employing a satellite downstream porting interface API (Application Programming Interface) to perform channel change according to various aspects the invention. The method begins by employing the embedded software to direct the DiSEqC to direct the LNB of a satellite dish to change (when necessary). The method then continues by employing the embedded software to direct the tune satellite tuner to tune to an appropriate frequency to try to receive a desired signal. This may be viewed as tuning to a particular portion of the frequency spectrum of interest in an effort to tune to a signal within that particular portion of the frequency spectrum. This may also involve setting the cut off frequency to be employed when performing the tuning.

The method then employs the embedded software to set acquisition parameters for 1 or more SDSs (integrated downstream satellite receivers) to ensure that a received signal is appropriately demodulated and decoded properly. This may involve directing various operational parameters such as the modulation, code rate, symbol rate, and/or any other operational parameter of the 1 or more SDSs. The method then continues by directing 1 or more of the SDSs to perform the actual acquisition of data according to the specified appropriate parameters.

In general, the satellite downstream porting interface modules that make up the satellite front end are the 1 or more satellite tuners and the 1 or more SDSs. The single chip satellite STB illustrated in many of the embodiments has a dual channel satellite front end, so there is an SDS device and a tuner device for each downstream. The SDS device is used for channel acquisition and DiSEqC functions, and the tuner device is used to control an external, off chip baseband tuner.

The SDS and tuner devices must first be opened with the bcmDeviceOpen( ) deviceinterface call. The pointers to the opened devices are used in subsequent SDS portinginterface calls. After opening the devices, the tuner, receiver and DiSEqC must be initialized for each downstream channel.

Below is sample code for initializing the SDS. For readability, the sample code provided herein does not perform error checking.

SBcmDevice SdsDevice[2];

SBcmDevice TunerDevice[2];

| // open all the SDS devices | | |
|---|---|---|
| bcmDeviceOpen(&SdsDevice[0], | eSds1Dev, | eDeviceNormal); |

bcmDeviceOpen(&TunerDevice[0], eTunerA, eDeviceNormal);

| | | |
|---|---|---|
| bcmDeviceOpen(&SdsDevice[1], | eSds2Dev, | eDeviceNormal); |

bcmDeviceOpen(&TunerDevice[1], eTunerB, eDeviceNormal);

// initialize tuner, receiver, and diseqc registers on both
downstreams
SdsCfg(&SdsDevice[0], &TunerDevice[0]);
SdsDiseqcReset(&SdsDevice[0], DISEQC_ANALOG_MODE_1);
SdsCfg(&SdsDevice[1], &TunerDevice[1]);
SdsDiseqcReset(&SdsDevice[1],DISEQC_ANALOG_MODE_1);

The following table provides an overview of the SDS initialization functions.

| Function | Description |
|---|---|
| SdsAInit | Initializes the SDS SBcmDevice structure for |
| | the first SDS. This function is automatically |
| | called when opening a device of type |
| | eSds1Dev in bcmDeviceOpen( ). |
| SdsBInit | Initializes the SDS SBcmDevice structure for |
| | the second SDS. This function is automatically |
| | called when opening a device of type eSds2Dev |
| | in bcmDeviceOpen( ). |
| SdsCfg | Initializes the SDS registers and initializes |
| | the BCM3440 tuner. This function also associates |
| | a tuner device with the SDS device. |
| SdsDiseqcReset | Resets the DISEQC block and reinitializes |
| | DISEQC registers according to the specified |
| | DISEQC analog mode. |

The application must enable the SDS RX1 and SDS RX2 interrupts in the Interrupt Controller after initializing the SDS downstream. When an SDS interrupt is occurs, the ISR function SdslntHandler( ) must be called with the SDS device pointer passed in.

Below is sample code for initializing the SDS interrupts:

// register an ISR called Sds1Isr( ) to the
SDS_RX1 interrupt in the
// Interrupt Controller
BcmMapInterrupt((FN_ISR)(Sds1Isr),
INTERRUPT_ID_SDS_RX1_IRQ, 0);
// enable the SDS_RX1 interrupt
BcmInterruptEnable(INTERRUPT_ID_SDS_RX1_IRQ);
// register an ISR called Sds2Isr( ) to the
SDS_RX2 interrupt in the
// Interrupt Controller
BcmMapInterrupt((FN_ISR)(Sds2Isr),
INTERRUPT_ID_SDS_RX2_IRQ, 0);
// enable the SDS_RX2 interrupt
BcmInterruptEnable(INTERRUPT_ID_SDS_RX2_IRQ);
Below are sample ISR functions for SDS RX1/RX2
interrupts:
void Sds1Isr( )
{

SdsIntHandler(&SdsDevice[0]);

}
void Sds2Isr( )
{

SdsIntHandler(&SdsDevice[1]);

}

The following table provides an overview of the SDS acquisition functions.

| Function | Description |
|---|---|
| SdsQpskSetSearchRange | Sets the search range for Legacy |
| | QPSK acquisitions. Default is +/−5.25 |
| | MHz for all baud rates. |
| SdsQpskSetSpInv | Sets the spectral inversion mode |
| | for subsequent Legacy QPSK |
| | acquisitions. The new spectral |
| | inversion mode will not take affect |
| | until the next call to SdsAcquire( ). |
| | The default mode is scan. |
| SdsFreezeTunerAgc | Freezes or activates the tuner AGC |
| | loop. This function is typically used |
| | for test purposes. |
| SdsFreezeIFAgc | Freezes or activates the IF AGC loop. |
| | This function is typically used for |
| | test purposes. |
| SdsSetIFAgc | Manually sets the gain of the IF AGC. |
| | This function is typically used for |
| | test purposes. |
| SdsSetTunerAgc | Manually sets the gain of the tuner AGC. |
| | This function is typically used for test |
| | purposes. |
| SdsFreezeEqualizer | Freezes or activates the equalizer. This |
| | function is typically used for test |
| | purposes. |
| bcm3440_tune | Tunes the BCM3440 to a specified |
| | frequency. |
| bcm3440_config | Manually sets the cutoff frequency of |
| | the BCM3440. |
| SdsAcquire | Starts channel acquisition based on |
| | specified input acquisition parameters. |

To acquire the downstream signal, first tune to the desired transponder frequency using bcm3440_tune( ), then call SdsAcquire( ) passing in the input acquisition parameters in the SSdsAcqParams data structure. SdsAcquire( ) initiates channel acquisition and then returns. The rest of the acquisition is done in the background, as the SDS interrupts will transition the SDS portinginterface through its acquisition state machine.

The code below is an example of how to acquire QPSK DVB rate 3/4 20 MBaud at transponder frequency 1119 MHz on SDS-0:

SSdsAcqParams acq_params;

// tune the tuner
bcm3440_tune(&TunerDevice[0], 1119.0);
// set up acquisition parameters
acq_params.mode = eQpskDVB;
acq_params.acq_control = SDS_DEFAULT_CONFIG;
acq_params.code_rate = eCodeRate_3_4;
acq_params.symbol_rate = 20.0;
acq_params.carrier_offset = 0.0;
// acquire

SdsAcquire(&SdsDevice[0], &acq_params);

The following table provides an overview of the SDS status functions.

| Function | Description |
|---|---|
| SdsGetQpskStatus | Returns Legacy QPSK channel status. |
| SdsGetTurboStatus | Returns Turbo channel status. |
| SdsIsLocked | Returns channel lock status. |
| SdsGetBer | Returns BER estimate if the internal BERT is |
| | enabled and locked. |
| SdsResetBERT | Resets the BER error count and elapsed time. |

The following table provides an overview of the DiSEqC functions.

| Function | Description |
|---|---|
| SdsDiseqcReset | Resets the DISEQC block and reinitializes |
| | DISEQC registers according to the specified |
| | DISEQC analog mode. |
| SdsDiseqcCalibrate | Adjusts the 22 KHz tone amplitude to the lowest |
| | level at which tone is detected. |
| SdsDiseqcSetVoltageLevel | Sets the LNB voltage level to VTOP or VBOT. |
| SdsDiseqcSetTone | Sets or removes continuous tone. |
| SdsDiseqcSendControl Word | Transmits an auto control word. |
| SdsDiseqcSetReceiveReplyTimeout | Sets or disables the receive reply timeout. |
| SdsDiseqcAdjustVoltageLevel | Adjusts the level of VTOP or VBOT. |
| SdsDiseqcGetStatus | Returns DISEQC status information |
| SdsDiseqcSend | Initiates the transmission of a DISEQC command. |
| SdsDiseqcSendCtl | Sets the tone burst mode and tone alignment when |
| | sending. |
| SdsDiseqcSetReceiveThreshold | Sets the receive threshold. |

To shutdown the satellite front end, follow the example code below.

// disable SDS1 interrupts
BcmInterruptDisable(INTERRUPT_ID_SDS_RX1_IRQ);
// Level-1 interrupt
SdsDisableInts(&SdsDevice[0]); // Level-2 interrupts
// disable SDS2 interrupts
BcmInterruptDisable(INTERRUPT_ID_SDS_RX2_IRQ);
// Level-1 interrupt
SdsDisableInts(&SdsDevice[1]); // Level-2 interrupts
// close SDS devices
bcmDeviceClose(&SdsDevice[0]);
bcmDeviceClose(&SdsDevice[1]);

The following table provides an overview of the SDS shutdown functions.

| Function | Description |
|---|---|
| SdsRelease | Frees all memory allocated by the SDS device |
| | and closes the device. This function is |
| | automatically called by bcmDeviceClose( ). |
| SdsDisableInts | Disables all interrupts within the SDS receiver. |
| | This function does not disable the (Level-1) |
| | SDS interrupt in the Interrupt Controller. |

In view of the above detailed description of the invention and associated drawings, other modifications and variations will now become apparent. It should also be apparent that such other modifications and variations may be effected without departing from the spirit and scope of the invention.

### Appendix

This section provides the description and syntax for all public SDS portinginterface API functions that may be employed in accordance with the scope and spirit of various aspects of the invention.

SDS Portinginiterface API Functions

This section provides the description and syntax for all public SDS portinginterface API functions.

SdsAInit

| | |
|---|---|
| Prototype: | #include “sds_main.h” |
| | EDeviceErrCode SdsAInit(SBcmDevice *Device); |
| Parameters: | Device = [output] pointer to the first SDS |
| | channel device |
| Return Value: | eDeviceSuccess if the SBcmDevice structure was |
| | successfully initialized |
| Description: | Initializes the SDS SBcmDevice structure associated |
| | with the first SDS core. This function is |
| | automatically called when opening a device of |
| | type eSds1Dev in bcmDeviceOpen( ). |

SdsBInit

| | |
|---|---|
| Prototype: | #include “sds_main.h” |
| | EDeviceErrCode SdsBInit(SBcmDevice *Device); |
| Parameters: | Device = [output] pointer to the second SDS |
| | channel device |
| Return Value: | eDeviceSuccess if the SBcmDevice structure was |
| | successfully initialized |
| Description: | Initializes the SDS SBcmDevice structure associated |
| | with the second SDS core. This function is |
| | automatically called when opening a device of type |
| | eSds2Dev in bcmDeviceOpen( ). |

SdsCfg

| | |
|---|---|
| Prototype: | #include “sds_main.h” |
| | EDeviceErrCode SdsCfg(SBcmDevice *Device, |
| | SBcmDevice *Tuner); |
| Parameters: | Device = [input] pointer to the SDS channel |
| | device |
| | Tuner = [input] pointer to the tuner device |
| | to be associated with the SDS channel device |
| Return Value: | eDeviceSuccess if successfully initialized |
| Description: | Initializes the SDS core registers and |
| | initializes the BCM3440 tuner. After opening |
| | the SDS and Tuner devices, this function |
| | should be called per downstream. |

SdsRelease

| | |
|---|---|
| Prototype: | #include “sds_main.h” |
| | EDeviceErrCode SdsRelease(SBcmDevice *Device); |
| Parameters: | Device = [input] pointer to the SDS device |
| Return Value: | eDeviceSuccess if the SDS was successfully closed |
| Description: | Frees all memory allocated by the SDS device and |
| | closes the device. This function is automatically |
| | called by bcmDeviceClose( ). |

SdsDisableInts

| | |
|---|---|
| Prototype: | #include “sds_main.h” |
| | EDeviceErrCode SdsDisableInts(SBcmDevice *Device); |
| Parameters: | Device = [input] pointer to the SDS device |
| Return Value: | eDeviceSuccess if the SDS device's interrupts have |
| | been disabled |
| Description: | This function disables the interrupts within the SDS |
| | core. The SDS RX1/RX2 interrupt mask in the Interrupt |
| | Controller is not changed. This function should be |
| | called by the application only when shutting down |
| | the SDS. |

SdsQpskSetSearchRange

| | |
|---|---|
| Prototype: | #include “sds_main.h” |
| | EDeviceErrCode SdsQpskSetSearchRange(SBcmDevice |
| | *Device, float |
| | search_range_mhz); |
| Parameters: | Device = [input] pointer to the SDS device |
| | search_range_mhz = search range in MHz |
| Return Value: | eDeviceSuccess if successful |
| Description: | Sets the search range for Legacy QPSK |
| | acquisitions. The new search range will take |
| | effect on subsequent acquisitions. Default |
| | is +/−5.25 MHz for all baud rates. |
| | Example: SdsQpskSetSearchRange(Device, 2.0) |
| | specifies a search range of +/−2MHz. |

SdsQpskSetSpInv

| | |
|---|---|
| Prototype: | #include “sds_main.h” |
| | EDeviceErrCode SdsQpskSetSpInv(SBcmDevice |
| | *Device, EspectralInversion |
| | spinv); |
| Parameters: | Device = [input] pointer to the |
| | SDS device |
| | spinv = [input] spectral inversion |
| | mode |
| Return Value: | eDeviceSuccess if successful |
| Description: | Sets the spectral inversion mode for subsequent |
| | Legacy QPSK acquisitions. The new spectral |
| | inversion mode will not take affect until the |
| | next call to SdsAcquire( ). Default is |
| | eSpinvScan. |

SdsFreezeTunerAgc

| | |
|---|---|
| Prototype: | #include “sds_main.h” |
| | EDeviceErrCode SdsFreezeTunerAgc(SBcmDevice |
| | *Device, unsigned char |
| | bFreeze); |
| Parameters: | Device = [input] pointer to the SDS device |
| | bFreeze: [input] 0=activate tuner AGC, |
| | non-zero=freeze tuner AGC |
| Return Value: | eDeviceSuccess if successful |
| Description: | Freezes or activates the tuner AGC loop. This |
| | function is typically used for test purposes. |

SdsFreezeIFAgc

| | |
|---|---|
| Prototype: | #include “sds_main.h” |
| | EDeviceErrCode SdsFreezeIFAgc(SBcmDevice *Device, |
| | unsigned char |
| | bFreeze); |
| Parameters: | Device = [input] pointer to the SDS device |
| | bFreeze: [input] 0=activate IF AGC, |
| | non-zero=freeze IF AGC |
| Return Value: | eDeviceSuccess if successful |
| Description: | Freezes or activates the IF AGC loop. This function |
| | is typically used for test purposes. |

SdsSetIFAgc

| | |
|---|---|
| Prototype: | #include “sds_main.h” |
| | EDeviceErrCode SdsSetIFAgc(SBcmDevice *Device, |
| | unsigned long gain); |
| Parameters: | Device = [input] pointer to the SDS device |
| | gain = [input] gain of the IF AGC |
| Return Value: | eDeviceSuccess if the IF AGC was successfully |
| | programmed |
| Description: | Sets the gain of the IF AGC. The 28-bit gain value |
| | is from bits 31 to 4. Bits 3 to 0 should be 0. |
| | This function is typically used for test purposes. |
| | The default gain value used by the SDS |
| | portinginterface is 0x3B000000. If the IF AGC |
| | gain is changed, then the input power status |
| | returned by the SdsGetQpskStatus( ) and |
| | SdsGetTurboStatus( ) functions will be invalid. |

SdsSetTunerAgc

| | |
|---|---|
| Prototype: | #include “sds_main.h” |
| | EDeviceErrCode SdsSetTunerAgc(SBcmDevice *Device, |
| | unsigned long gain); |
| Parameters: | Device = [input] pointer to the SDS device |
| | gain = [input] gain of the tuner AGC |
| Return Value: | eDeviceSuccess if the tuner AGC was successfully |
| | programmed |
| Description: | Sets the gain of the tuner AGC. The 28-bit gain |
| | value is from bits 31 to 4. Bits 3 to 0 should |
| | be 0. This function is typically used for test |
| | purposes. The default gain value programmed by |
| | the SDS portinginterface is 0x7A000000. If the |
| | tuner AGC gain is changed, then the input power |
| | status returned by the SdsGetQpskStatus( ) |
| | and SdsGetTurboStatus( ) functions will be |
| | invalid. |

SdsFreezeEqualizer

| | |
|---|---|
| Prototype: | #include “sds_main.h” |
| | EDeviceErrCode SdsFreezeEqualizer(SBcmDevice |
| | *Device, unsigned char |
| | bFreeze); |
| Parameters: | Device = [input] pointer to the SDS device |
| | bFreeze: [input] 0=activate equalizer, |
| | non-zero=freeze equalizer |
| Return Value: | eDeviceSuccess if successful |
| Description: | Freezes or activates the equalizer. This |
| | function is typically used for test purposes. |

SdsAcquire

| Prototype: | #include “sds_main.h” | | |
|---|---|---|---|
| | EDeviceErrCode SdsAcquire(SBcmDevice *Device, SSdsAcqParams | | |
| | *acq_params); | | |
| Parameters: | Device = [input] pointer to the SDS device | | |
| | acq_params = [input] acquisition parameters | | |
| Return Value: | eDeviceSuccess if successful | | |
| Description: | Starts the channel acquisition based on input parameters provided by the | | |
| | SSdsAcqParams structure (see section 9.3.3). The valid values for each member | | |
| | of the SSdsAcqParams structure are given below. | | |
| | SSdsAcqParams | | |
| | member | Valid values | |
| | mode | Enumerated type ESdsMode (see section 9.3.1) | |
| | | eQpskDVB - Legacy QPSK, DVB | |
| | | eQpskDSS - Legacy QPSK, DSS | |
| | | eQpskDCII - Legacy QPSK, Digicipher-II | |
| | | eTurboQpsk - Turbo QPSK | |
| | | eTurbo8PSK - Turbo 8PSK | |
| | symbol_rate | In units of Mbaud. Valid range is 15.0 to 30.0. This | |
| | | value should also include the baud offset. | |
| | code_rate | Enumerated type ECodeRate (see section 9.3.2) | |
| | | The supported code rates for each mode are given below. | |
| | | For DVB/DSS: ½, ⅔, ¾, ⅚, 6/7, ⅞, scan | |
| | | For DCII: 5/11, ⅗, ⅘, ⅚, ⅞, scan | |
| | | For Turbo 8PSK: ⅔, ⅚, 8/9, ¾_2.10, ¾_2.05, scan | |
| | | For Turbo QPSK: ½, ⅔, ¾, ⅚, ⅞, scan | |
| | carrier_offset | In units of MHz | |
| | acq_control | 32-bit hex number. Default is CLKINV \| TEI \| | |
| | | TURBO_SYNC_INS \| NYQUIST (0x04410200). | |
| | | Bit | Description |
| | | 4:0 | Stuff bytes - number of stuff bytes |
| | | 5 | ERRINV - PS_ERR inversion control |
| | | | 0 = PS_ERR is active high |
| | | | 1 = PS_ERR is active low |
| | | 6 | SYNCINV - PS_SYNC inversion control |
| | | | 0 = PS_SYNC is active high |
| | | | 1 = PS_SYNC is active low |
| | | 7 | VLDINV - PS_VALID inversion control |
| | | | 0 = PS_VALID is active high |
| | | | 1 = PS_VALID is active low |
| | | 8 | CLKSUP - clock suppression control |
| | | | 0 = PS_CLK runs continuously |
| | | | 1 = PS_CLK is suppressed when PS_VALID |
| | | | is not active |
| | | 9 | CLKINV - PS_CLK inversion control |
| | | | 0 = PS_CLK is normal |
| | | | 1 = PS_CLK is inverted |
| | | 10 | SERIAL |
| | | | 0 = parallel data out |
| | | | 1 = serial data out |
| | | 11 | DELH - Delete the MPEG header. This bit |
| | | | can be used to invalidate the header data. The |
| | | | data itself will never be deleted when this bit |
| | | | is active, but PS_VALID will be set to zero to |
| | | | indicate header data. The PS_VALID |
| | | | duration is then defined by HEAD4 bit. |
| | | | 0 = no effect |
| | | | 1 = PS_VALID will be low for 1 byte at the |
| | | | beginning of the packet if HEAD4=0. If |
| | | | HEAD4=1, PS_VALID will be low for 4 |
| | | | bytes at the beginning of the packet. |
| | | 12 | HEAD4 - MPEG packet header length |
| | | | definition. This control bit defines the |
| | | | duration of PS_VALID and PS_SYNC |
| | | | outputs. It has no effect on the data itself. |
| | | | 0 = Header is 1 byte long |
| | | | 1 = Header is 4 bytes long |
| | | 13 | SYNC1 - PS_SYNC duration definition in |
| | | | serial mode. |
| | | | 0 = no effect on PS_SYNC. PS_SYNC is |
| | | | either 1 byte (HEAD4=0), or 4 bytes |
| | | | (HEAD4=1) long at the beginning of the |
| | | | packet. |
| | | | 1 = In serial mode, PS_SYNC will be valid |
| | | | for 1 bit at the beginning of the packet. This |
| | | | bit has no effect in parallel mode. In parallel |
| | | | mode, PS_SYNC duration is defined by the |
| | | | HEAD4 bit as above. |
| | | 14 | DELAY - output delay |
| | | | 0 = normal operation |
| | | | 1 = delay PS_ERR, PS_VALID, and |
| | | | PS_DATA relative to PS_CLK |
| | | 15 | XBERT - external BERT select |
| | | | 0 = PS_CLK runs continuously |
| | | | 1 = PS_CLK is suppressed when PS_SYNC is |
| | | | active |
| | | 16 | TEI - Set transport error indicator flag in |
| | | | MPEG2 transport stream when an |
| | | | uncorrectable error occurs. |
| | | | 0 = TEI flag off |
| | | | 1 = TEI flag on |
| | | 17 | OQPSK - applies to Legacy QPSK modes |
| | | | only |
| | | | 0 = QPSK |
| | | | 1 = OQPSK |
| | | 18 | SPLIT - applies to Legacy QPSK modes only |
| | | | 0 = combine |
| | | | 1 = split |
| | | 19 | SPLIT_Q - applies to Legacy QPSK mode |
| | | | and SPLIT=1 |
| | | | 0 = split I |
| | | | 1 = split Q |
| | | 20 | reserved |
| | | 21 | PRBS_15 |
| | | | 0 = PRBS_23 |
| | | | 1 = PRBS_15 |
| | | 22 | NYQUIST - sets the receiver matched filter |
| | | | bandwidth |
| | | | 0 = alpha is 0.35 |
| | | | 1 = alpha is 0.20 |
| | | 23 | reserved |
| | | 24 | TUNER_CUTOFF_BYP |
| | | | 0 = normal operation |
| | | | 1 = BCM3440 tuner cutoff not programmed |
| | | | during acquisition |
| | | 25 | ENABLE_BERT - enables internal BERT for |
| | | | test purposes |
| | | | 0 = disabled |
| | | | 1 = enabled |
| | | 26 | TURBO_SYNC_INS - Turbo only. Turbo |
| | | | modulator deletes 0x47 sync bytes. For |
| | | | MPEG applications, SDS re-inserts the 0x47 |
| | | | sync bytes. Do not use for data applications. |
| | | | 0 = non-MPEG use. Do not insert sync bytes |
| | | | 1 = MPEG use: re-insert sync bytes |
| | | 31:27 | reserved |

SdsGetQpskStatus

| | |
|---|---|
| Prototype: | #include “sds_main.h” |
| | EDeviceErrCode SdsGetQpskStatus(SBcmDevice |
| | *Device, SQpskDsStatus |
| | *status); |
| Parameters: | Device = [input] pointer to the SDS device |
| | status = [output] pointer to structure that |
| | contains status information (see |
| | section 9.3.4) |
| Return Value: | eDeviceSuccess if returned status is valid |
| Description: | This function returns the following Legacy QPSK |
| | channel status information: |
| | Modulation |
| | Code rate |
| | Tuner frequency in MHz |
| | Sample frequency in MHz |
| | Actual symbol rate in MBaud |
| | Carrier frequency error in MHz |
| | Output bit rate in Mbps |
| | SNR estimate in dB |
| | Input power in dBm |
| | BER (if BERT enabled and locked) |
| | BER errors (if BERT enabled and locked) |
| | FEC phase |
| | Number of RS correctable errors since last |
| | status read |
| | Number of RS uncorrectable errors since last |
| | status read |
| | RS lock indication |
| | Viterbi lock indication |
| | BERT lock indication |

SdsGetTurboStatus

| | |
|---|---|
| Prototype: | #include “sds_main.h” |
| | EDeviceErrCode SdsGetTurboStatus(SBcmDevice |
| | *Device, STurboDsStatus |
| | *status); |
| Parameters: | Device = [input] pointer to the SDS device |
| | status = [output] pointer to structure that |
| | contains status information (see |
| | section 9.3.5) |
| Return Value: | eDeviceSuccess if returned status is valid |
| Description: | This functions returns the following Turbo |
| | channel status information: |
| | Modulation |
| | Code rate |
| | Tuner frequency in MHz |
| | Sample frequency in MHz |
| | Actual symbol rate in MBaud |
| | Carrier frequency error in MHz |
| | Output bit rate in Mbps |
| | SNR estimate in dB |
| | Input power in dBm |
| | BER (if BERT enable and locked) |
| | BER errors (if BERT enabled and locked) |
| | Number of bad blocks since last status read |
| | Number of clean blocks since last status read |
| | Number of correctable blocks since last status read |
| | Number of correctable symbols since last status read |
| | Bits per symbol |
| | Receiver lock indication |
| | FEC lock indication |
| | BERT lock indication |

SdsIsLocked

| | |
|---|---|
| Prototype: | #include “sds_main.h” |
| | unsigned char SdsIsLocked(SBcmDevice *Device); |
| Parameters: | Device = [input] pointer to the SDS device |
| Return Value: | Non-zero if locked |
| Description: | In Turbo mode, if the receiver and FEC are |
| | both locked, then the function returns non-zero. |
| | In Legacy QPSK mode, if the Reed-Solomon and |
| | Viterbi are both locked, then the function |
| | returns non-zero. |

SdsGetBer

| | |
|---|---|
| Prototype: | #include “sds_main.h” |
| | EDeviceErrCode SdsGetBer(SBcmDevice *Device, |
| | double *ber); |
| Parameters: | Device = [input] pointer to the SDS device |
| | ber = [output] BER estimate |
| Return Value: | eDeviceSuccess if output BER estimate is valid |
| Description: | This function returns the BER estimate if the |
| | internal BERT is enabled and locked. |

SdsResetBERT

| | |
|---|---|
| Prototype: | #include “sds_main.h” |
| | EDeviceErrCode SdsResetBERT(SBcmDevice *Device); |
| Parameters: | Device = [input] pointer to the SDS device |
| Return Value: | eDeviceSuccess if successful |
| Description: | Resets the BER error count and elapsed time. |

SdsDiseqcReset

| | |
|---|---|
| Prototype: | #include “sds_diseqc.h” |
| | EDeviceErrCode SdsDiseqcReset(SBcmDevice *Device, |
| | EDiseqcAnalogMode |
| | analog_mode); |
| Parameters: | Device = [input] pointer to the SDS device |
| | analog_mode = [input] DISEQC analog mode |
| Return Value: | eDeviceSuccess if successful |
| Description: | Resets the DISEQC block and reinitializes |
| | DISEQC registers according to the specified |
| | DISEQC analog mode. Currently, the BCM7328 |
| | SDS Portinginterface supports only |
| | DISEQC_ANALOG_MODE_1. |

SdsDiseqcCalibrate

| | |
|---|---|
| Prototype: | #include “sds_diseqc.h” |
| | EDeviceErrCode SdsDiseqcCalibrate(SBcmDevice |
| | *Device, EDiseqcToneAmplitude rcv_thresh, |
| | unsigned char *bPassed); |
| Parameters: | Device = [input] pointer to the SDS device |
| | rcv_thresh = [input] receive threshold |
| | level for DISEQC RX signal |
| | bPassed = [output] flag that indicates |
| | if calibration passed |
| Return Value: | eDeviceSuccess if bPassed is valid |
| Description: | Adjusts the 22 KHz tone amplitude to the |
| | lowest level at which tone is detected. |
| | bPassed returns non-zero if calibration was |
| | successful. The specified rcv_thresh is used |
| | for calibration only, not for normal receive. |
| | To program the normal receive threshold, use |
| | SdsDiseqcSetReceiveThreshold( ). |

SdsDiseqcSetReceiveThreshold

| | |
|---|---|
| Prototype: | #include “sds_diseqc.h” |
| | EDeviceErrCode |
| | SdsDiseqcSetReceiveThreshold(SBcmDevice |
| | *Device, |
| | EDiseqcToneAmplitude threshold); |
| Parameters: | Device = [input] pointer to the SDS device |
| | threshold = [input] receive threshold |
| Return Value: | eDeviceSuccess if successful |
| Description: | This function sets the receive threshold. The |
| | default value is EDiseqcToneAmplitude_125 mVPP. |

SdsDiseqcSetVoltageLevel

| | |
|---|---|
| Prototype: | #include “sds_diseqc.h” |
| | EDeviceErrCode |
| | SdsDiseqcSetVoltageLevel(SBcmDevice *Device, |
| | EDiseqcVoltageLevel level); |
| Parameters: | Device = [input] pointer to the SDS device |
| | level = [input] LNB voltage level to set |
| Return Value: | eDeviceSuccess if successful |
| Description: | This function sets the voltage level to VTOP or |
| | VBOT. |

SdsDiseqcSetTone

| | |
|---|---|
| Prototype: | #include “sds_diseqc.h” |
| | EDeviceErrCode SdsDiseqcSetTone(SBcmDevice |
| | *Device, EDiseqcTone |
| | tone); |
| Parameters: | Device = [input] pointer to the SDS device |
| | tone = [input] tone absent/present |
| Return Value: | eDeviceSuccess if successful |
| Description: | This function sets or removes the 22 KHz |
| | continuous tone. |

SdsDiseqcSendControlWord

| | |
|---|---|
| Prototype: | #include “sds_diseqc.h” |
| | EDeviceErrCode |
| | SdsDiseqcSendControlWord(SBcmDevice *Device, |
| | unsigned |
| | char cw); |
| Parameters: | Device = [input] pointer to the SDS device |
| | cw = [input] auto control word to send |
| Return Value: | eDeviceSuccess if successful |
| Description: | This function initiates the transmission of |
| | an auto control word and then returns. |
| | The DISEQC state will be set to DISEQC_ACW |
| | for the duration of the transmission, which |
| | will be 96 milliseconds. After transmission, |
| | the error status is saved in the last_error |
| | member of SDiseqcStatus structure, which is |
| | returned by the SdsDiseqcGetStatus( ) function. |

SdsDiseqcSetReceiveReplyTimeout

| | |
|---|---|
| Prototype: | #include “sds_diseqc.h” |
| | EDeviceErrCode |
| | SdsDiseqcSetReceiveReplyTimeout(SBcmDevice |
| | *Device, |
| | unsigned long timeout); |
| Parameters: | Device = [input] pointer to the SDS device |
| | timeout = [input] timeout in microseconds |
| Return Value: | eDeviceSuccess if successful |
| Description: | This function sets the receive reply timeout. |
| | If timeout is 0, then the receive reply timeout |
| | is disabled. Changes will take effect on |
| | subsequent calls to SdsDiseqcSend( ). |

SdsDiseqcSendCtl

| Prototype: | #include “sds_diseqc.h” | |
|---|---|---|
| | EDeviceErrCode SdsDiseqcSendCtl(SBcmDevice | |
| | *Device, unsigned long ctl); | |
| Parameters: | Device = [input] pointer to the SDS device | |
| | ctl = [input] control flags | |
| Return Value: | eDeviceSuccess if successful | |
| Description: | This function sets the tone burst mode and tone | |
| | alignment when sending. Changes will take effect | |
| | on subsequent calls to SdsDiseqcSend( ). | |
| | Bit in ctl | |
| | parameter | Description |
| | 0 | Tone burst |
| | | 0 = disabled (default) |
| | | 1 = enabled |
| | 1 | Tone select (when tone burst |
| | | mode is enabled) |
| | | 0 = tone A |
| | | 1 = tone B |
| | 2 | Tone alignment mode |
| | | 0 = disabled |
| | | 1 = enabled (default) |

SdsDiseqcSend

| | |
|---|---|
| Prototype: | #include “sds_diseqc.h” |
| | EDeviceErrCode SdsDiseqcSend(SBcmDevice |
| | *Device, unsigned char *buf, |
| | int n); |
| Parameters: | Device = [input] pointer to the SDS device |
| | buf = [input] pointer to data buffer to send |
| | n = [output] number of bytes to send; |
| | for DISEQC receive only mode, set n = 0 |
| Return Value: | eDeviceSuccess if successful |
| Description: | Initiates the transmission of a DISEQC |
| | command to a DISEQC slave device. |
| | Prior to calling SdsDiseqcSend( ), the |
| | transmission parameters can be |
| | configured with the SdsDiseqcSendCtl( ) |
| | function, and the receive reply timeout |
| | can be set or disabled with the |
| | SdsDiseqcSetReceiveReplyTimeout( ) function. |
| | If n = 0, no bytes are sent and DISEQC |
| | will be placed in a receive-only mode. |
| | The DISEQC state will be set to |
| | DISEQC_TRANSACTION for the duration of |
| | the transaction. The error status and any |
| | reply bytes received are internally saved |
| | and can be returned in the SDiseqcStatus |
| | structure by the SdsDiseqcGetStatus( ) |
| | function. |

SdsDiseqcGetStatus

| | |
|---|---|
| Prototype: | #include “sds_diseqc.h” |
| | EDeviceErrCode SdsDiseqcGetStatus(SBcmDevice |
| | *Device, SDiseqcStatus |
| | *pStatus); |
| Parameters: | Device = [input] pointer to the SDS device |
| | pStatus = [output] pointer to structure |
| | containing DISEQC status |
| Return Value: | eDeviceSuccess if pStatus is valid |
| Description: | Returns the DISEQC status information in the |
| | SDiseqcStatus structure (see section 9.3.12). |

SdsDiseqcAdjustVoltageLevel

| | |
|---|---|
| Prototype: | #include “sds_diseqc.h” |
| | EDeviceErrCode |
| | SdsDiseqcAdjustVoltageLevel(SBcmDevice *Device, |
| | EDiseqcVoltageLevel level, unsigned char ctl); |
| Parameters: | Device = [input] pointer to the SDS device |
| | level = [input] specifies VBOT or VTOP to adjust |
| | ctl = [input] 7-bit value. 0x00 is approximately |
| | 12 V and 0x7F is approximately 20 V. |
| Return Value: | eDeviceSuccess if successful |
| Description: | Adjusts the level of VBOT or VTOP. |

Tuner API Functions

This section describes the API for controlling the BCM3440 tuner.

bcm3440_tune

| | |
|---|---|
| Prototype: | #include “bcm3440.h” |
| | EDeviceErrCode bcm3440_tune(SBcmDevice *Device, |
| | float freq); |
| Parameters: | Device = [input] pointer to the SDS device |
| | freq = [input] frequency in MHz |
| Return Value: | eDeviceSuccess if successful |
| Description: | Tunes the BCM3440 to a specified frequency. |

bcm3440_config

| | |
|---|---|
| Prototype: | #include “bcm3440.h” |
| | EDeviceErrCode bcm3440_config(SBcmDevice |
| | *Device, unsigned char |
| | cutoff); |
| Parameters: | Device = [input] pointer to the SDS device |
| | cutoff = [input] cutoff frequency in MHz |
| Return Value: | eDeviceSuccess if successful |
| Description: | Manually sets the cutoff frequency of the BCM3440. |

Structures and Data Types

This section defines the structures and data types used in the SDS portinginterface API.

ESdsMode

| Include file: | sds_main.h |
|---|---|
| Description: | This enumerated type specifies the modulation type. |
| Definition: | typedef enum |
| | { |

eQpskDVB, /* Legacy QPSK, DVB */
eQpskDSS, /* Legacy QPSK, DSS */
eQpskDCII, /* Legacy QPSK, DigicipherII */
eTurboQpsk,/* Turbo QPSK */
eTurbo8psk /* Turbo 8PSK */

| | } ESdsMode; |
|---|---|
| Used in: | SdsAcquire( ), SdsGetQpskStatus( ), |
| | SdsGetTurboStatus( ) |

ECodeRate

| | |
|---|---|
| Include file: | sds_main.h |
| Description: | This enumerated type specifies the code rate. |
| Definition: | typedef enum |

{

eCodeRate_scan = 0,
eCodeRate_1_4, /* rate ¼ */
eCodeRate_1_2, /* rate ½ */
eCodeRate_2_3, /* rate ⅔ */
eCodeRate_3_4, /* rate ¾ */
eCodeRate_5_6, /* rate ⅚ */
eCodeRate_6_7, /* rate 6/7 */
eCodeRate_7_8, /* rate ⅞ */
eCodeRate_5_11, /* rate 5/11 */
eCodeRate_3_5, /* rate ⅗ */
eCodeRate_4_5, /* rate ⅘ */
eCodeRate_8_9, /* rate 8/9 */
eCodeRate_3_4_2_05, /* rate ¾,
2.05 bits/symbol */
eCodeRate_3_4_2_10, /* rate ¾,
2.1 bits/symbol */
eCodeRate_unknown = 0xFF

| | } ECodeRate; |
|---|---|
| Used in: | SdsAcquire( ), SdsGetQpskStatus( ), |

SdsGetTurboStatus( )

SSdsAcqParams

| Include file: | sds_main.h |
|---|---|
| Description: | This structure specifies input parameters for |
| | channel acquisition. |
| Definition: | typedef struct |
| | { |

| | |
|---|---|
| ESdsMode | mode; /* modulation type */ |
| unsigned | long acq_control;/* see below */ |
| ECodeRate | code_rate; /* code rate */ |

| | |
|---|---|
| float | symbol_rate;/* in Mbaud */ |
| float | carrier_offset;/* in MHz */ |

| } SSdsAcqParams; | |
|---|---|
| /* bit definitions for SSdsAcqParams.acq_control | |
| */ | |
| #define SDS_STUFF_MASK | 0x0000001F |

| | |
|---|---|
| #define SDS_ERRINV | 0x00000020 |
| #define SDS_SYNCINV | 0x00000040 |
| #defme SDS_VLDINV | 0x00000080 |
| #define SDS_CLKSUP | 0x00000100 |
| #define SDS_CLKINV | 0x00000200 |

| | |
|---|---|
| #define SDS_SERIAL | 0x00000400 |
| #define SDS_DELH | 0x00000800 |
| #define SDS_HEAD4 | 0x00001000 |
| #defineSDS_SYNC1 | 0x00002000 |
| #define SDS_DELAY | 0x00004000 |
| #defineSDS_XBERT | 0x00008000 |

| | |
|---|---|
| #define SDS_TEI | 0x00010000 |

| | |
|---|---|
| #defineSDS_OQPSK | 0x00020000 |
| #define SDS_SPLIT | 0x00040000 |

| | |
|---|---|
| #define SDS_SPLIT_Q | 0x00080000 |

| | |
|---|---|
| #define SDS_PN | 0x00100000 |

| | |
|---|---|
| #define SDS_PRBS_15 | 0x00200000 |
| #define SDS_NYQUIST | 0x00400000 |

| | |
|---|---|
| #define SDS_BYPASS_STFLIF | 0x00800000 |

| #define SDS_BYPASS_TUNER_CUTOFF 0x01000000 | |
|---|---|
| #define SDS_ENABLE_BERT | 0x02000000 |

| | |
|---|---|
| #define SDS_TURBO_SYNC_INS | 0x04000000 |

| | |
|---|---|
| #define SDS_SPLIT_IQ_SCAN | 0x08000000 |

| | /* default value for SSdsAcqParams.acq_control |
|---|---|
| | */ |
| | #define SDS_DEFAULT_CONFIG (SDS_CLKINV |
| | \| SDS TEI \| |
| | SDS_TURBO_SYNC_INS \| SDS_NYQUIST) |
| Used in: | SdsAcquire( ) |

SQpskDsStatus

| Include file: | sds_main.h |
|---|---|
| Description: | This structure contains Legacy QPSK channel status. |
| Definition: | typedef struct |
| | { |

| | |
|---|---|
| ESdsMode | mode; |
| ECodeRate | code_rate; |

| float | tuner_freq; | |
|---|---|---|
| float | sample_freq; | /* actual sample freq |
| | | in MHz */ |
| float | symbol_rate; | /* actual symbol rate |
| | | in Msps */ |
| float | carrier_error; | /* carrier error in |
| | | MHz */ |
| float | output_bit_rate; | /* output bit rate |
| | | in Mbps */ |
| float | snr_estimate; | /* SNR in dB */ |

| | | |
|---|---|---|
| double | ber_estimate; | /* BER */ |

| | | |
|---|---|---|
| float | input_power; | /* input power |

| | | estimate in dB */ |
|---|---|---|
| ESpectralInversion spinv; | | |
| EFecPhase fec_phase; | | |
| unsigned long | rs_corr; | /* RS correctable |
| | | errors */ |
| unsigned long | rs_uncorr; | /* RS uncorrectable |
| | | errors */ |
| unsigned long | ber_errors; | /* BER error count */ |
| unsigned char | rs_locked; | /* non-zero = |
| | | locked */ |
| unsigned char | vit_locked; | /* non-zero = |
| | | locked */ |
| unsigned char | bert_locked; | /* non-zero = |

locked */

| | } SQpskDsStatus; |
|---|---|
| Used in: | SdsGetQpskStatus( ) |

STurboDsStatus

| Include file: | sds_main.h |
|---|---|
| Description: | This structure contains Turbo channel status. |
| Definition: | typedef struct |
| | { |

| | |
|---|---|
| ESdsMode | mode; |
| ECodeRate | code_rate; |

| float | tuner_freq; | |
|---|---|---|
| float | sample_freq; | /* actual sample |
| | | freq in MHz */ |
| float | symbol_rate; | /* actual symbol |
| | | rate in Msps */ |
| float | carrier_error; | /* carrier error |
| | | in MHz */ |
| float | output_bit_rate; | /* output bit rate |
| | | in Mbps */ |
| float | snr_estimate; | /* SNR in dB */ |

| | | |
|---|---|---|
| double | ber_estimate; | /* BER */ |

| | | |
|---|---|---|
| float | input_power; | /* input power |

estimate in dB */

| | |
|---|---|
| unsigned long | bad_block_count; |
| unsigned long | clean_block_count; |
| unsigned long | corr_block_count; |
| unsigned long | corr_sym_count; |

| | |
|---|---|
| float | bits_per_symbol; |

| unsigned long | ber_errors; | /* BER error |
|---|---|---|
| | | count */ |
| unsigned char | rcvr_locked; | /* non-zero = |
| | | locked */ |
| unsigned char | fec_locked; | /* non-zero = |
| | | locked */ |
| unsigned char | bert_locked; | /* non-zero = |

locked */

| | } STurboDsStatus; |
|---|---|
| Used in: | SdsGetTurboStatus( ) |

ESpectralInversion

| Include file: | sds_main.h |
|---|---|
| Description: | This enumerated type specifies the spectral |
| | inversion mode for Legacy QPSK mode. |
| Definition: | typedef enum |

{

eSpinvNormal = 0,
eSpinvIInv,
eSpinvQInv,
eSpinvScan,

| | } ESpectralInversion; |
|---|---|
| Used in: | SdsQpskSetSpInv( ) |

EFecPhase

| Include file: | sds_main.h |
|---|---|
| Description: | This enumerated type specifies the FEC phase |
| | for Legacy QPSK mode only. |
| Definition: | typedef enum |

{

eFecPhase0 = 0,
eFecPhase90,
eFecPhase270,
eFecPhase180

| | } EFecPhase; |
|---|---|
| Used in: | SdsGetQpskStatus( ) |

EDiseqcState

| Include file: | sds_diseqc.h |
|---|---|
| Description: | This enumerated type specifies the current |
| | state of the DISEQC software. |
| Definition: | typedef enum |
| | { |

| DISEQC_IDLE, | /* ready to accept next |
|---|---|
| operation */ | |
| DISEQC_TRANSACTION, /* send/receive in | |
| progress */ | |
| DISEQC_ACW, | /* ACW in progress */ |
| DISEQC_BUSY | |

| | } EDiseqcState; |
|---|---|
| Used in: | SdsDiseqcGetStatus( ) |

EDiseqcTone

| Include file: | sds_diseqc.h |
|---|---|
| Description: | This enumerated type specifies the whether |
| | transmitted tone is absent or present. |
| Definition: | typedef enum |

{

DISEQC_UNKNOWN_TONE,
DISEQC_TONE_ABSENT,
DISEQC_TONE_PRESENT

| | } EDiseqcTone; |
|---|---|
| Used in: | SdsDiseqcGetStatus( ), SdsDiseqcSetTone( ) |

EDiseqcVoltageLevel

| Include file: | sds_diseqc.h |
|---|---|
| Description: | This enumerated type indicates the LNB voltage |
| | level. |
| Definition: | typedef enum |

{

DISEQC_UNKNOWN_VOLTAGE,
DISEQC_VBOT, /* typically 13 Volts */
DISEQC_VTOP /* typically 18 Volts */

| | } EDiseqcVoltageLevel; |
|---|---|
| Used in: | SdsDiseqcGetStatus( ), |

SdsDiseqcAdjustVoltageLevel( ),
SdsDiseqcSetVoltageLevel( )

EDiseqcAnalogMode

| Include File: | sds_diseqc.h |
|---|---|
| Description: | This enumerated type specifies the DISEQC |
| | analong mode. The BCM7328 SDS portinginterface |
| | currently supports only DISEQC_ANALOG_MODE_1. |
| Definition: | typedef enum |
| | { |

DISEQC_EXTERNAL = 0,/* 7328 not used
for DISEQC */
DISEQC_ANALOG_MODE_1,
DISEQC_ANALOG_MODE_2, /* currently not
supported */
DISEQC_ANALOG_MODE_3, /* currently not
supported */
DISEQC_ANALOG_MODE_3I, /* currently not
supported */
DISEQC_ANALOG_MODE_4 /* currently not
supported */

| | } EDiseqcAnalogMode; |
|---|---|
| Used in: | SdsDiseqcReset( ) |

SDiseqcStatus

| | |
|---|---|
| Include file: | sds_diseqc.h |
| Description: | This structure contains current DISEQC status. |
| Definition: | typedef struct |

{

| | |
|---|---|
| EDiseqcState | state; |

| EDiseqcTone | tone; |
|---|---|
| EDiseqcVoltageLevel level; | |
| EDiseqcError | last_error; |
| unsigned char | reply expected; |
| /* non-zero if reply is expected */ | |
| unsigned char | reply_bytes; /* number |

of reply bytes received and stored in

reply_buffer */

| | |
|---|---|
| unsigned char | parity_error; |

/* this byte indicates which reply byte(s)
had parity

errors:

bit 0: parity error in
reply byte 0
bit 1: parity error in
reply byte 1
...
bit 7: parity error in
reply byte 7 */

unsigned char reply_buffer[8];

| | } SDiseqcStatus; |
|---|---|
| Used in: | SdsDiseqcGetStatus( ) |

EDiseqcError

| Include file: | sds_diseqc.h |
|---|---|
| Description: | This enumerated type specifies the error generated |
| | from sending a command. |
| Definition: | typedef enum |

{

DISEQC_NO_ERROR = 0,
DISEQC_RX_END_REPLY_TIMEOUT,
DISEQC_RX_OVERFLOW,
DISEQC_RX_REPLY_TIMEOUT,
DISEQC_RX_PARITY_ERROR,
DISEQC_RX_DEMOD_ERROR,
DISEQC_ACW_TIMEOUT,
DISEQC_SW_ERROR

| | } EDiseqcError; |
|---|---|
| Used in: | SdsDiseqcGetStatus( ) |

EDiseqcToneAmplitude

| Include file: | sds_diseqc.h |
|---|---|
| Description: | This enumerated type specifies the |
| | peak-peak tone amplitude. |
| Definition: | typedef enum |
| | { |

EDiseqcToneAmplitude_125mVPP = 0, /* 125 mV
PP */
EDiseqcToneAmplitude_170mVPP, /* 170 mV PP */
EDiseqcToneAmplitude_220mVPP, /* 220 mV PP */
EDiseqcToneAmplitude_325mVPP, /* 325 mV PP */
EDiseqcToneAmplitude_430mVPP, /* 430 mV PP */
EDiseqcToneAmplitude_525mVPP, /* 525 mV PP */
EDiseqcToneAmplitude_630mVPP, /* 630 mV PP */
EDiseqcToneAmplitude_730mVPP /* 730 mV PP */

| | } EDiseqcToneAmplitude; |
|---|---|
| Used in: | SdsDiseqcCalibrate( ), |
| | SdsDiseqcSetReceiveThreshold( ) |

Functional Mapping to BCM4500 HAB Command Set

| | |
|---|---|
| BCM4500 HAB Command | Equivalent or similar BCM7328 |
| | portinginterface function(s) |
| Tune Tuner | bcm3440_tune( ) |
| Tune Transponder | — |
| Tuner Set | bcm3440_config( ) |
| Cutoff Frequency | |
| Acquire | SdsAcquire( ) |
| Status Turbo | SdsGetTurboStatus( ) |
| Status Legacy | SdsGetQpskStatus( ) |
| Status BER | SdsGetBer( ) |
| Status FFE | — |
| Legacy Acq Range Select | SdsQpskSetSearchRange( ) |
| Auto Control Word | SdsDiseqcSendControlWord( ) |
| Freeze Tuner AGC Loop | SdsFreezeTunerAgc( ) |
| Activate Tuner AGC Loop | SdsFreezeTunerAgc( ) |
| Freeze IF AGC Loop | SdsFreezeIFAgc( ) |
| Activate IF AGC Loop | SdsFreezeIFAgc( ) |
| Manual Set IF AGC | SdsSetIFAgc( ) |
| Manual Set Tuner AGC | SdsSetTunerAgc( ) |
| Edit Symbol Rate Listed | — |
| Set Alternate Bandwidth | — |
| Version | — |
| Reset Decoder Block | Not applicable since SDS portinginterface |
| | does not keep an accumulated count of |
| | clean/correctable/bad turbo blocks, or |
| | correctable/uncorrectable errors in |
| | Legacy QPSK mode. |
| DISEQC Control | SdsDiseqcSetVoltageLevel( ), |
| | SdsDiseqcSetTone( ) |
| DISEQC Send | SdsDiseqcSend( ), send parameters |
| | are configurated with |
| | SdsDiseqcSetReceiveReplyTimeout( ) |
| | and SdsDiseqcSendCtl( ) functions |
| DISEQC Read | SdsDiseqcGetStatus( ) |
| DISEQC Receive Threshold | SdsDiseqcSetReceiveThreshold( ) |

1. A satellite receiver STB (Set Top Box) system, comprising:
a single chip satellite receiver STB (Set Top Box) that includes an integrated microprocessor that is operable to run satellite downstream porting interface API (Application Programming Interface) software and an SDS (integrated downstream satellite receiver) communicatively couple to the integrated microprocessor;
an off-chip satellite tuner communicatively coupled to the single chip satellite receiver STB that is operable to extract I, Q (In-phase, Quadrature) components of a received signal and is operable to pass the I, Q components to the SDS of the single chip satellite receiver STB;
wherein the integrated microprocessor of the single chip satellite receiver STB is operable to provide first control signals to the off-chip satellite tuner via an I²C (inter-integrated circuits) bus as directed by the satellite downstream porting interface API software;
wherein, within the single chip satellite receiver STB, the integrated microprocessor of the single chip satellite receiver STB is operable to provide second control signals to the SDS as directed by the satellite downstream porting interface API software;
wherein the satellite downstream porting interface API software that runs on the integrated microprocessor of the single chip satellite receiver STB governs at least one operational parameter of the off-chip satellite tuner when receiving a signal; and
wherein the satellite downstream porting interface API software that runs on the integrated microprocessor of the single chip satellite receiver STB governs at least one operational parameter of the SDS when demodulating and subsequently decoding the I, Q components of the received signal.

2. The satellite receiver STB system of claim 1, wherein:
the single chip satellite receiver STB includes an integrated DiSEqC (Digital Satellite Equipment Control) functional block that is operable to communicate with an LNB (Low Noise Block) of a satellite dish;
within the single chip satellite receiver STB, third control signals are communicatively coupled from the integrated microprocessor to the integrated DiSEqC functional block; and
the integrated DiSEqC functional block is operable to provide DiSEqC control signals to adjust at least one of a voltage and a polarization of the LNB of the satellite dish.

3. The satellite receiver STB system of claim 1, wherein:
the single chip satellite receiver STB includes an integrated DiSEqC (Digital Satellite Equipment Control) functional block that is operable to communicate with an LNB (Low Noise Block) of a satellite dish;
within the single chip satellite receiver STB, third control signals are communicatively coupled from the integrated microprocessor to the integrated DiSEqC functional block; and
the satellite downstream porting interface API software that runs on the integrated microprocessor of the single chip satellite receiver STB governs at least one operational parameter of the control words employed by the DiSEqC functional block to control the LNB of the satellite dish.

4. The satellite receiver STB system of claim 3, wherein:
the satellite downstream porting interface API software that runs on the integrated microprocessor of the single chip satellite receiver STB governs at least one operational parameter of the control words employed by the DiSEqC functional block to control the LNB of the satellite dish in response to a channel change request that is provided to the single chip satellite receiver STB.

5. The satellite receiver STB system of claim 1, wherein:
the second control signals that are communicatively coupled from the integrated microprocessor to the SDS include information corresponding to at least one of a modulation, a code rate, and a symbol rate by which the received signal is to be demodulated and subsequently decoded.

6. The satellite receiver STB system of claim 1, wherein:
the at least one operational parameter employed by the off-chip satellite tuner when receiving a signal includes at least one of a tuning frequency and a cut off frequency.

7. The satellite receiver STB system of claim 1, wherein:
the satellite downstream porting interface API software that runs on the integrated microprocessor of the single chip satellite receiver STB governs at least one operational parameter of the off-chip satellite tuner when receiving a signal in response to a channel change request that is provided to the single chip satellite receiver STB.

8. The satellite receiver STB system of claim 1, wherein:
the satellite downstream porting interface API software that runs on the integrated microprocessor of the single chip satellite receiver STB governs at least one operational parameter of the SDS when demodulating and subsequently decoding the I, Q components of the received signal in response to a channel change request that is provided to the single chip satellite receiver STB.

9. The satellite receiver STB system of claim 1, wherein:
the satellite receiver STB system is implemented within at least one of a satellite communication system and an HDTV (High Definition Television) communication system.

10. A satellite receiver STB (Set Top Box) system, comprising:
a single chip satellite receiver STB (Set Top Box) that includes an integrated microprocessor that is operable to run satellite downstream porting interface API (Application Programming Interface) software and an SDS (integrated downstream satellite receiver) communicatively couple to the integrated microprocessor;
wherein the single chip satellite receiver STB includes an integrated DiSEqC (Digital Satellite Equipment Control) functional block that is operable to communicate with an LNB (Low Noise Block) of a satellite dish;
an off-chip satellite tuner communicatively coupled to the single chip satellite receiver STB that is operable to extract I, Q (In-phase, Quadrature) components of a received signal and is operable to pass the I, Q components to the SDS of the single chip satellite receiver STB;
wherein the integrated microprocessor of the single chip satellite receiver STB is operable to provide first control signals to the off-chip satellite tuner via an I²C (inter-integrated circuits) bus as directed by the satellite downstream porting interface API software;
wherein, within the single chip satellite receiver STB, the integrated microprocessor of the single chip satellite receiver STB is operable to provide second control signals to the SDS as directed by the satellite downstream porting interface API software;
wherein, within the single chip satellite receiver STB, third control signals are communicatively coupled from the integrated microprocessor to the integrated DiSEqC functional block;
wherein the satellite downstream porting interface API software that runs on the integrated microprocessor of the single chip satellite receiver STB governs at least one operational parameter of the off-chip satellite tuner when receiving a signal;
wherein the satellite downstream porting interface API software that runs on the integrated microprocessor of the single chip satellite receiver STB governs at least one operational parameter of the SDS when demodulating and subsequently decoding the I, Q components of the received signal; and
wherein the satellite downstream porting interface API software that runs on the integrated microprocessor of the single chip satellite receiver STB governs at least one operational parameter of the control words employed by the DiSEqC functional block to control the LNB of the satellite dish.

11. The satellite receiver STB system of claim 10, wherein:
the integrated DiSEqC functional block is operable to provide DiSEqC control signals to adjust at least one of a voltage and a polarization of the LNB of the satellite dish.

12. The satellite receiver STB system of claim 10, wherein:
the satellite downstream porting interface API software that runs on the integrated microprocessor of the single chip satellite receiver STB governs at least one operational parameter of the control words employed by the DiSEqC functional block to control the LNB of the satellite dish in response to a channel change request that is provided to the single chip satellite receiver STB.

13. The satellite receiver STB system of claim 10, wherein:
the second control signals that are communicatively coupled from the integrated microprocessor to the SDS include information corresponding to at least one of a modulation, a code rate, and a symbol rate by which the received signal is to be demodulated and subsequently decoded.

14. The satellite receiver STB system of claim 10, wherein:
the at least one operational parameter employed by the off-chip satellite tuner when receiving a signal includes at least one of a tuning frequency and a cut off frequency.

15. The satellite receiver STB system of claim 10, wherein:
the satellite downstream porting interface API software that runs on the integrated microprocessor of the single chip satellite receiver STB governs at least one operational parameter of the off-chip satellite tuner when receiving a signal in response to a channel change request that is provided to the single chip satellite receiver STB.

16. The satellite receiver STB system of claim 10, wherein:
the satellite downstream porting interface API software that runs on the integrated microprocessor of the single chip satellite receiver STB governs at least one operational parameter of the SDS when demodulating and subsequently decoding the I, Q components of the received signal in response to a channel change request that is provided to the single chip satellite receiver STB.

17. The satellite receiver STB system of claim 10, wherein:
the satellite receiver STB system is implemented within at least one of a satellite communication system and an HDTV (High Definition Television) communication system.

18. A method for performing a channel change within a satellite receiver STB (Set Top Box) system using satellite downstream porting interface API (Application Programming Interface) software that runs within an integrated microprocessor integrated within a single chip satellite receiver STB (Set Top Box), the method comprising:
receiving a signal using an off-chip satellite tuner, communicatively coupled to the single chip satellite receiver STB, that is operable to extract I, Q (In-phase, Quadrature) components of the received signal according to at least one operational parameter of the off-chip satellite tuner;
passing the I, Q components of the received signal to an SDS (integrated downstream satellite receiver), implemented within the single chip satellite receiver STB, that is operable to operable to perform demodulation and subsequent decoding of the I, Q components of the received signal according to at least one operational parameter of the SDS;
selecting the at least one operational parameter of the off-chip satellite tuner using the downstream porting interface API software in response to a channel change request that is provided to the single chip satellite receiver STB; and
selecting the at least one operational parameter of the SDS using the downstream porting interface API software in response to a channel change request that is provided to the single chip satellite receiver STB.

19. The method of claim 18, further comprising:
selecting at least one operational parameter of control words employed by a DiSEqC (Digital Satellite Equipment Control) functional block that is integrated within the single chip satellite receiver STB to control an LNB (Low Noise Block) of a satellite dish using the downstream porting interface API software in response to a channel change request that is provided to the single chip satellite receiver STB.

20. The method of claim 18, further comprising:
using the downstream porting interface API software to direct a DiSEqC (Digital Satellite Equipment Control) functional block that is integrated within the single chip satellite receiver STB to provide DiSEqC (Digital Satellite Equipment Control) control signals to adjust at least one of a voltage and a polarization of an LNB (Low Noise Block) of a satellite dish.
